(19) United States
(12) Patent Application Publication
(10) Pub. No.: US 2026/0288872 A1
(43) Pub. Date: Sep. 24, 2026

(54) SYSTEM

(71) Applicant: SoftBank Group Corp., Tokyo (JP)

(72) Inventor: Yasutaka HIKIDA, Tokyo (JP)

(73) Assignee: SoftBank Group Corp., Tokyo (JP)

(21) Appl. No.: 19/562,965

(22) Filed: Mar. 11, 2026

(30) Foreign Application Priority Data
Mar. 19, 2025 (JP) 2025-044997

(51) Int. Cl. G06F 16/9032

(52) U.S. Cl. CPC G06F 16/90332

(57) ABSTRACT

A system includes a processor that is configured to provide an interface for receiving a question from a user, analyze the received question by using a natural language processing technique and generate a prompt that instructs a generative AI model to generate a response related to agriculture, and generate an optimal response related to agriculture by using the generative AI model based on the generated prompt.

### CROSS-REFERENCE TO RELATED APPLICATION

This application is based on and claims priority under 35 USC 119 from Japanese Patent Application No. 2025-044997 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional agricultural advisory systems and question-answering platforms have several limitations when serving beginner users in agriculture. First, many systems rely on static rule-based knowledge bases or manually curated FAQs, which cannot flexibly handle the wide variety of natural language questions that users actually input. As a result, the relevance and specificity of the responses are often insufficient, leading to confusion or incorrect agricultural practices by beginners.

Second, existing systems typically do not adapt their responses to the emotional state of the user. Beginner users in agriculture frequently experience anxiety, frustration, or lack of confidence when facing crop failures or pest outbreaks. When the system ignores such emotional conditions, the responses may be perceived as insensitive, overly technical, or difficult to follow, thereby reducing user satisfaction and the effectiveness of the guidance. Third, while a large amount of question-and-answer data may be generated through user interactions, conventional systems do not effectively utilize such accumulated data to discover new business opportunities. In particular, questions from beginner users often reflect latent needs for services, products, or educational programs, but these needs remain unrecognized when the data is not systematically stored and analyzed.

Therefore, there is a need for a system that can: (i) receive and understand user questions in natural language and generate optimal responses related to agriculture using a generative AI model; (ii) recognize user emotions based on voice and facial expressions and adjust responses accordingly; and (iii) store and analyze questions and responses, especially from beginner users in agriculture, in order to explore potential new commercialization opportunities.

### SUMMARY

In order to solve the above problems, according to one aspect of the present invention, there is provided a system comprising a processor, wherein the processor is configured to provide an interface for receiving a question from a user, to analyze the received question by using a natural language processing technique and to generate a prompt that instructs a generative AI model to generate a response related to agriculture, and to generate an optimal response related to agriculture by using the generative AI model based on the generated prompt. By employing a generative AI model in combination with natural language processing, the system can flexibly interpret a wide range of user questions and produce contextually appropriate and specific answers for agricultural beginners.

In one embodiment, the processor is further configured to recognize an emotion of the user by using a voice analysis technique and a facial expression recognition technique, and to adjust the response based on a recognition result. For example, when the processor detects frustration or anxiety from the user's voice or facial expression, the processor can adjust the tone, level of detail, and structure of the response to be more reassuring, step-by-step, and supportive, thereby improving user experience and enhancing the effectiveness of the guidance.

In another embodiment, the processor is further configured to store, in a database, questions from beginner users in agriculture and responses to the questions, and to analyze accumulated data stored in the database to explore a possibility of new commercialization. By systematically collecting and analyzing such data, the processor can identify frequently asked topics, unmet needs, and emerging trends among beginner users, and can output indicators or reports useful for planning new products, services, or business models in the agricultural domain.

The term “system” refers to an arrangement of one or more hardware and/or software components configured to execute the functions described in the present specification and claims, and may include servers, client devices, networks, and storage devices operating individually or in combination.

The term “processor” refers to any hardware component or combination of hardware components that executes instructions, including but not limited to a central processing unit (CPU), a graphics processing unit (GPU), a digital signal processor (DSP), an application specific integrated circuit (ASIC), a field programmable gate array (FPGA), or a plurality thereof.

The term “interface” refers to a hardware and/or software component configured to receive input from, and/or provide output to, a user or another system, and may include graphical user interfaces, command line interfaces, application programming interfaces (APIs), web forms, mobile application screens, voice interfaces, and the like.

The term “user” refers to any person who operates a terminal or client device to input a question to, receive a response from, or otherwise interact with, the system, and may include an agricultural beginner, an experienced farmer, an agricultural advisor, or any other stakeholder.

The term “question” refers to an inquiry, request for information, or problem description provided by the user in natural language, text, voice, or another communicative form, which is intended to obtain a response related to agriculture from the system.

The term “natural language processing technique” refers to a computational method or algorithm for processing, understanding, or generating human language, including but not limited to tokenization, parsing, part-of-speech tagging, named entity recognition, intent detection, semantic analysis, and natural language understanding or generation.

The term “prompt” refers to a piece of data, including text and optionally additional structured information, generated by the processor and provided as input to a generative AI model, the prompt specifying conditions, instructions, or context used by the generative AI model to generate a response.

The term “generative AI model” refers to a machine learning model trained to generate language or other content in response to input data, and may include, but is not limited to, large language models, transformer-based models, encoder-decoder models, or other neural network architectures capable of generating responses related to agriculture.

The term “response” refers to information generated by the generative AI model and/or the processor in reply to a question, and may include explanations, recommendations, procedures, warnings, or other content intended to address the user's inquiry.

The term “optimal response” refers to a response that is determined, based on the design and configuration of the system, to be suitable for the user's question under given conditions, for example by being relevant, accurate, clear, and appropriate in view of agricultural practices and user needs.

The term “emotion” refers to a psychological or affective state of the user, including but not limited to happiness, satisfaction, frustration, anxiety, confusion, or anger, which can be inferred from user signals and used to adapt the system's behavior.

The term “voice analysis technique” refers to a method of processing audio data representing the user's speech in order to extract features such as pitch, tone, volume, speech rate, or prosody, and to infer information including, but not limited to, the user's emotion or state.

The term “facial expression recognition technique” refers to a method of processing image or video data of the user's face to detect or classify facial expressions, and to infer information such as the user's emotion, engagement level, or attentiveness.

The term “adjust the response” refers to modifying one or more aspects of a response, including content, tone, level of detail, structure, or presentation format, based on information such as the recognized emotion of the user or other contextual factors.

The term “database” refers to a logical or physical data storage system configured to store, manage, and retrieve structured or unstructured data, and may include relational databases, NoSQL databases, data warehouses, or other storage mechanisms.

The term “beginner users in agriculture” refers to users who have relatively limited knowledge, experience, or skills in agricultural practices, and who seek basic or introductory guidance related to farming, gardening, cultivation, or related activities.

The term “accumulated data” refers to data stored over time by the system, including, but not limited to, questions, responses, timestamps, user attributes, and analysis results, which can be used for further processing, learning, or analysis.

The term “analyze accumulated data” refers to applying statistical, machine learning, rule-based, or other computational techniques to the accumulated data in order to extract patterns, trends, correlations, or insights.

The term “commercialization” refers to the planning, development, offering, or operation of products, services, platforms, or business models that address user needs identified from the accumulated data, including but not limited to agricultural advisory services, educational content, tools, equipment, or digital solutions.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

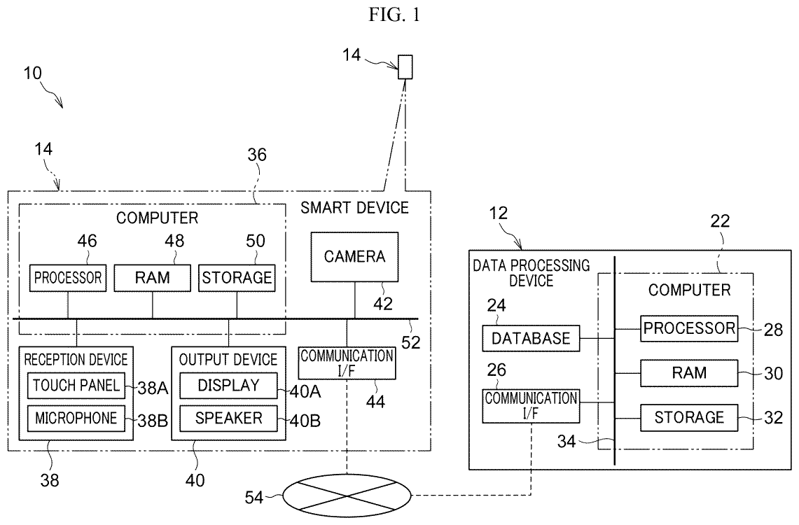

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

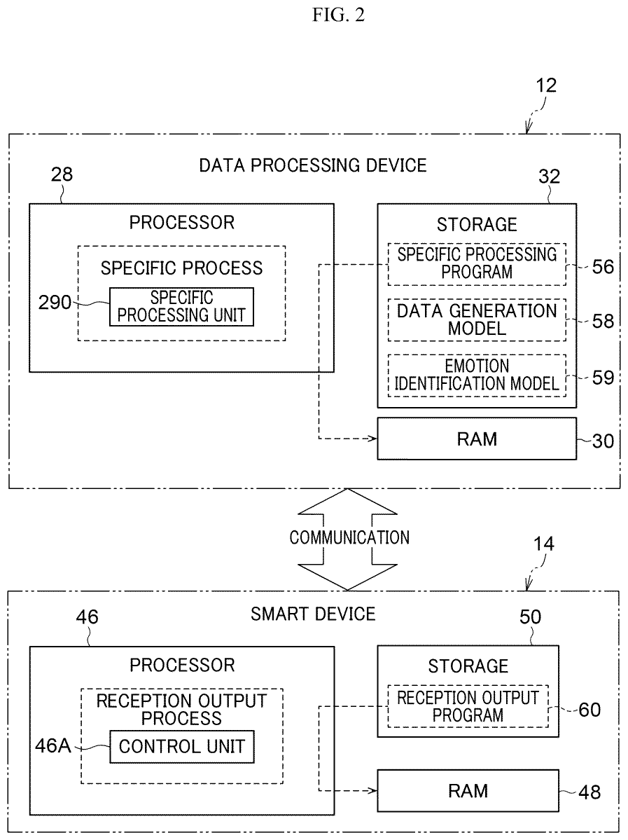

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented question-answering systems that utilize a generative AI model typically focus on generating a single response to an isolated user query. Such systems are generally optimized only for short-term interaction quality, and do not systematically capture, structure, and exploit question-and-response data at scale. As a result, the underlying computer infrastructure is not configured to perform integrated processes that (i) transform large volumes of unstructured natural language interaction data into structured, analyzable data objects, and (ii) feed back analysis results to reconfigure or optimize subsequent processing. This limitation reduces the efficiency, scalability, and adaptability of the overall computing system.

More specifically, existing systems suffer from several technical deficiencies. First, the interface layer between user input and the generative AI model is usually implemented as a simple text pass-through, without a dedicated prompt sentence construction mechanism that performs semantic analysis, feature extraction, and attribute estimation to dynamically tailor prompt sentences to the characteristics of the incoming question. As a consequence, the generative AI model is not consistently driven by context-aware, machine-optimized input representations, which can lead to suboptimal resource utilization and degraded response quality on the computing platform.

Second, conventional architectures do not tightly integrate the generative AI model with a persistent storage subsystem and a data analysis subsystem in a manner that treats question-and-response pairs as structured computational objects. Typically, logging of interactions is ad hoc, and the recorded data is not subject to systematic classification, aggregation, and time-series analysis driven by the same or a related generative AI model. This prevents the computing system from using its own historical interaction data to discover stable patterns and high-demand fields, and to reconfigure its behavior based on objective, machine-derived analysis results.

Third, current systems inadequately incorporate user-state information, such as emotional state, into the computational pipeline in a way that technically alters model control parameters and prompt construction. While superficial sentiment detection may be performed at the application layer, there is no unified computational mechanism that uses recognized emotional features to adjust, at the processor level, the condition descriptions in prompt sentences and the output control parameters of the generative AI model. This omission leads to inefficient utilization of model capacity and network resources, because the system cannot adapt its computational behavior to different user states in a technically meaningful way. Fourth, conventional systems are not architected to automatically identify and structure commercialization candidate information, such as high-demand service categories, using embedded representations and cluster-distance calculations executed by machine-learning models. As a result, the underlying computing resources are not used to transform raw interaction logs into higher-level, machine-tractable business opportunity objects, which could otherwise guide automatic or semi-automatic configuration of services on the computing platform.

Accordingly, there is a need for an improved computer-implemented system that: (1) automatically constructs optimized prompt sentences for a generative AI model based on semantic and attribute analysis of user questions; (2) persistently stores question-and-response data in association with identification and time information; (3) performs integrated classification, aggregation, time-series analysis, and embedding-based clustering of the stored data to extract high-demand fields and derive commercialization candidate information; and (4) optionally adapts prompt construction and model output control parameters based on an automatically recognized emotional state of the user. Such a system would improve the functioning of the computer itself by providing a unified processing pipeline that transforms unstructured interaction streams into structured, analyzable, and actionable data, and that configures generative processing based on these machine-derived insights.

The specific processing by the specific processing unit 290 of the data processing device 12 in Example 1 is realized by the following means.

The present invention provides a server comprising a processor configured to receive, via an input/output device of an information processing apparatus, a natural language question from a user; to analyze the received question by using a natural language processing algorithm to perform semantic analysis, feature extraction, and attribute estimation on the question; to construct, based on a result of the analysis, a prompt sentence to be input to a generative information processing model; to supply the constructed prompt sentence to the generative information processing model as input data and cause the generative information processing model to execute statistical language inference processing to generate a response sentence related to an application field; to convert a result of the generation into response data in an output data structure capable of being presented to the user; to store question data received from the user and response data generated by the generative information processing model in association with identification information and time information in a storage area of a recording device; and to analyze a plurality of stored question-and-response data items by using data analysis algorithms including classification processing, aggregation processing, and time-series processing and by using vectorization and similarity calculation processing performed by at least one of the generative information processing model and another language model, thereby performing trend recognition and demand extraction and deriving, based on a result of the analysis, commercialization candidate information related to a service or a product. This enables the computer system to implement an integrated processing pipeline that (i) transforms unstructured natural language interaction streams into structured data objects suitable for large-scale machine analysis, (ii) optimizes prompt sentence construction and model control parameters as a function of analyzed interaction patterns and, optionally, recognized emotional states, and (iii) automatically identifies and outputs high-demand fields and commercialization candidate information, thereby improving the overall technical performance, adaptability, and resource utilization efficiency of the underlying computing infrastructure.

The term “information processing apparatus” refers to an electronic apparatus that executes machine-readable instructions to process data, including at least one processor, memory, and an input/output interface, such as a computer, a server, or a terminal device. The term “processor” refers to one or more hardware processing units, such as a central processing unit or a graphics processing unit, capable of executing instructions to perform arithmetic operations, logical operations, control operations, and data transfer operations. The term “input/output device” refers to a hardware component or combination of hardware components that allow data to be input to, or output from, an information processing apparatus, including, for example, a display, a keyboard, a pointing device, a touch panel, a microphone, a camera, or a network interface.

The term “natural language question” refers to text data or speech data expressing an inquiry in a human language, such as a sentence or phrase, which is interpretable by a natural language processing algorithm.

The term “natural language processing algorithm” refers to a software procedure or model that processes natural language data to perform at least one of tokenization, part-of-speech tagging, syntactic parsing, semantic analysis, feature extraction, or intent detection.

The term “semantic analysis” refers to processing that interprets the meaning or intent of natural language text by identifying semantic relations, roles, or concepts represented in the text.

The term “feature extraction” refers to processing that converts raw data, including natural language data, voice data, or image data, into a set of structured values or vectors that capture salient characteristics of the data.

The term “attribute estimation” refers to processing that infers one or more attributes related to a natural language question or a user, such as topic category, difficulty level, user expertise, or emotional state.

The term “prompt sentence” refers to a text sequence, including at least one instruction and optionally context information, that is supplied as input to a generative information processing model to control or guide generation of an output.

The term “generative information processing model” refers to a machine learning model, such as a neural network-based language model, that generates output data, including text, based on input data by performing statistical inference over learned parameters.

The term “statistical language inference processing” refers to processing by which a generative information processing model predicts one or more output tokens or sequences of tokens based on probabilistic relationships learned from training data.

The term “response sentence” refers to a text sequence generated by a generative information processing model as an answer or reaction to a natural language question represented by a prompt sentence.

The term “response data” refers to data representing at least one response sentence, optionally including associated metadata such as a format flag, a confidence score, or a classification label.

The term “output data structure” refers to an arrangement of fields or elements in memory or in a storage medium that stores response data in a form suitable for output to a user or another system component, such as a record, an object, or a message.

The term “question data” refers to data representing a natural language question received from a user, including text data and, optionally, associated metadata such as a user identifier, a timestamp, or a category label.

The term “identification information” refers to data used to uniquely or distinctively identify a question, a response, a user, or a record, such as an identifier, a session ID, or a user account ID.

The term “time information” refers to data representing a temporal value associated with an event, including at least one of a date, a time, or a time interval, such as a timestamp indicating when a question or response was generated or stored.

The term “recording device” refers to a hardware component or subsystem capable of storing data in a non-transitory manner, such as a magnetic disk device, a solid-state drive, an optical storage device, or a memory subsystem.

The term “storage area” refers to a logical or physical region of a recording device allocated to store one or more data items, such as a file, a table, a record, or a block.

The term “data analysis algorithm” refers to a software procedure that processes stored data to derive aggregated values, patterns, or statistical summaries, including at least one of classification processing, aggregation processing, or time-series processing.

The term “classification processing” refers to processing that assigns one or more category labels to data items based on their features, using rule-based logic, statistical methods, or machine learning models.

The term “aggregation processing” refers to processing that combines multiple data items to compute summary values, such as counts, sums, averages, frequencies, or distributions.

The term “time-series processing” refers to processing that analyzes data items arranged in temporal order to detect trends, seasonality, changes, or other temporal patterns.

The term “vectorization” refers to processing that converts data, including text data, image data, or audio data, into numerical vectors, typically using an embedding model or feature extraction method.

The term “similarity calculation processing” refers to processing that computes a degree of similarity or distance between two or more vectors, using a metric such as cosine similarity, Euclidean distance, or inner product.

The term “trend recognition” refers to processing that identifies stable or evolving patterns over time within data, such as increases, decreases, periodicities, or recurring topics.

The term “demand extraction” refers to processing that identifies topics, categories, or fields for which user questions or interactions occur with relatively high frequency or intensity.

The term “commercialization candidate information” refers to data indicating one or more potential products, services, or business offerings that are inferred to have potential market demand based on analysis of question-and-response data.

The term “service” refers to an offering that provides ongoing or discrete functionality or information to a user, such as a continuous information-provision service, a material-provision service, or an educational-content-provision service.

The term “product” refers to a physical object or a digital good that can be offered or supplied to a user in a commercial context, including, for example, consumable items, tools, equipment, or software.

The term “user” refers to any human or entity that provides a question to, receives a response from, or otherwise interacts with the system through an input/output device.

The term “voice data” refers to audio signals or digital data representing spoken utterances of a user, captured by a microphone or an audio input device.

The term “image data” refers to visual signals or digital data representing an appearance of a user or an environment, captured by a camera or an image input device.

The term “acoustic feature extraction processing” refers to processing that converts voice data into numerical or symbolic features, such as pitch, energy, spectral coefficients, or prosodic attributes.

The term “image feature extraction processing” refers to processing that converts image data into numerical or symbolic features, such as edges, textures, facial landmarks, or region descriptors.

The term “machine learning model” refers to a model whose parameters are determined, at least in part, by training on example data, including neural networks, decision trees, support vector machines, or ensemble models.

The term “emotional state” refers to a condition or attitude of a user, such as happiness, sadness, frustration, calmness, or confusion, as inferred from data including voice data, image data, or textual data.

The term “condition description” refers to a part of a prompt sentence that specifies constraints, roles, styles, or other conditions controlling the behavior of a generative information processing model.

The term “output control parameter” refers to a parameter that influences the output behavior of a generative information processing model, such as a temperature value, a maximum output length, a sampling parameter, or a diversity parameter.

The term “crop type” refers to a category of agricultural plant, such as a species or variety, used for classification of questions or responses.

The term “cultivation-environment type” refers to a category representing a growing environment for a crop, such as open field, greenhouse, indoor, or container cultivation.

The term “user-attribute type” refers to a category representing a characteristic of a user, such as experience level, role, or region.

The term “similar-question clustering processing” refers to processing that groups questions into clusters based on similarity of content or features, using at least one of text similarity, vector similarity, or pattern matching.

The term “embedding representation” refers to a vector representation of a data item, such as a sentence or document, obtained by an embedding model or a layer of a language model.

The term “cluster distance” refers to a measure of separation between clusters, computed based on distances between embedding representations of cluster centroids or cluster members.

The term “high-demand field” refers to a topic area, category, or application domain identified as having relatively high user interest or interaction frequency based on analysis of stored data.

The term “continuous information-provision service” refers to a service that repeatedly or periodically supplies information to a user over time, typically based on a subscription or ongoing interaction.

The term “material-provision service” refers to a service that facilitates provision or recommendation of physical or digital materials related to an application field.

The term “educational-content-provision service” refers to a service that provides tutorials, lessons, or other instructional content to a user in a structured or semi-structured manner.

In one embodiment, a server cooperates with at least one terminal operated by a user to implement the claimed system. The server functions as an information processing apparatus that includes at least one processor, a main memory, a non-transitory storage device, and a network interface. The terminal is implemented as a portable or fixed communication device, such as a smartphone, a tablet, or a personal computer, including an input/output device such as a touch display, a microphone, and a camera. The user operates the terminal to input natural language questions and to receive generated responses.

The server executes an application program running on a general-purpose operating system. The server uses a web application framework, such as a generic HTTP server with an application layer implemented in a scripting or compiled language, and a database management system, such as a relational database, to store question-and-response data. The server further uses a generative AI model, implemented for example as a transformer-based neural network language model, that is deployed either on the same server or on a separate model server accessible via a network. The terminal executes a client application, such as a web browser or a native application, that communicates with the server using a communication protocol such as HTTPS over TCP/IP.

The server constructs and executes a program that transforms unstructured natural language interactions into structured data objects suitable for machine analysis, and that feeds back analysis results into subsequent processing. The server uses a modular architecture in which functional modules correspond to specific hardware and software components.

### A. Hardware and Software Configuration

The server includes:
(1) A processor that executes instructions implementing natural language processing algorithms, data analysis algorithms, and control logic. The processor may comprise one or more central processing units and optionally one or more graphics processing units configured for parallel numerical computation.
(2) A main memory that stores runtime data structures, including token sequences, embedding vectors, prompt sentences, question-and-response records, and intermediate analysis results.
(3) A storage device, such as a magnetic disk device or a solid-state drive, that stores a database of question-and-response records, configuration parameters, and pre-trained model weights for the generative AI model or associated embedding models.
(4) A network interface that exchanges request and response messages with the terminal and with an external or internal model server that executes the generative AI model.

The terminal includes:
(1) An input/output device comprising at least a display, a user input interface (such as a touch panel or keyboard), a microphone, and optionally a camera.
(2) A communication module that sends HTTP or HTTPS requests containing question data to the server and receives HTTP or HTTPS responses containing answer data from the server.
(3) A rendering module that displays text responses, and optionally graphical elements, on the display for the user.

### B. Natural Language Question Acquisition and Preprocessing

The terminal acquires a natural language question from the user through the input/output device. The terminal converts key inputs or speech inputs into a Unicode text string, which is encoded in a common character encoding such as UTF-8. The terminal constructs an internal data object representing the question text and associated metadata, such as a tentative user identifier and local timestamp, and transmits this object to the server via a network using an application-layer communication protocol.

The server receives a network message containing the question text and metadata. The server parses the message using an HTTP library and converts the encoded text into a native string representation in main memory. The server then applies a natural language processing algorithm to perform semantic analysis, feature extraction, and attribute estimation.

In one embodiment, the server uses a pipeline composed of:
(1) Tokenization, in which the server divides the question text into tokens using a rule-based tokenizer or a subword tokenizer, resulting in a sequence of token identifiers.
(2) Part-of-speech tagging and syntactic parsing, in which the server applies a statistical or neural parser to derive grammatical structure, dependency relations, and phrase boundaries.
(3) Semantic role labeling and topic classification, in which the server uses a trained classifier to determine an application-specific topic label (for example, crop type or cultivation environment) and to identify semantic roles such as “target crop” or “requested operation”.
(4) Attribute estimation, in which the server infers one or more attributes such as user experience level (beginner, intermediate, expert), question urgency level, or question type (how-to, troubleshooting, planning) based on extracted features and a machine learning classifier.

The server represents the extracted features and attributes as structured data, such as key-value pairs or vectors, stored in main memory. This structured representation serves as input to downstream prompt construction and analysis modules.

### C. Prompt Sentence Construction for a Generative AI Model

The server constructs a prompt sentence to provide a structured, context-rich instruction to the generative AI model. The server uses a template-based prompt generation module that combines:
(1) A system-level instruction section specifying a role for the generative AI model and constraints for its output.
(2) A context section containing information derived from semantic analysis and attribute estimation, such as recognized crop type, user experience level, and environmental conditions.
(3) A user-question section containing the original natural language question or a normalized version of the question.

In one embodiment, the server uses a template such as: You are an agricultural advisor AI. Answer the following question in a clear and practical way for a beginner.

Question: Please tell me how to grow tomatoes.

In another embodiment, the server incorporates additional context:

You are an expert crop consultant. Provide step-by-step instructions for a novice home gardener.

Question: How should I water and fertilize tomatoes grown in pots on a sunny balcony?

The server generates these prompt sentences by concatenating fixed instruction strings with variable segments derived from the analysis pipeline. The server ensures that the prompt sentence explicitly encodes attributes that were inferred by the natural language processing algorithm, such as “novice home gardener” or “pots on a sunny balcony”, thereby guiding the generative AI model to produce focused, context-appropriate responses. This structured prompt construction represents a non-conventional interface between the user question and the generative AI model that improves response relevance and reduces the number of tokens required for disambiguation, thereby improving processing efficiency.

### D. Generative AI Model Structure and Operation

The server uses a generative AI model implemented as a transformer-based neural network language model, which comprises:
(1) An embedding layer that maps discrete token identifiers into continuous vectors of a fixed dimension.
(2) A stack of multi-head self-attention layers, each of which computes attention scores over the input token sequence and combines context vectors for each token.
(3) Position-wise feedforward networks that apply nonlinear transformations to the context vectors.
(4) A final linear projection and softmax layer that compute probability distributions over a vocabulary for the next token prediction.

The generative AI model is pre-trained on large corpora and optionally fine-tuned on domain-specific agricultural texts. The server stores model weights in a storage device and loads necessary portions into memory. The model is executed on numerical computing hardware, such as a graphics processing unit configured to perform matrix multiplications and vector operations.

The server encodes the constructed prompt sentence using a tokenizer consistent with the generative AI model and obtains a sequence of token identifiers. The server supplies this sequence, and optionally additional control parameters such as a temperature value and a maximum generation length, to the generative AI model. The server then causes the model to perform autoregressive generation: for each generation step, the model computes a probability distribution over the next token, selects a token using a sampling method (such as top-k sampling or nucleus sampling), appends the selected token to the sequence, and repeats until a termination condition is met.

The server configures the model execution with parameters that are adjusted at runtime based on recognized attributes. For example, the server reduces the maximum generation length and temperature for novice users to produce concise, stable responses, and increases variety for advanced users. This dynamic parameter adjustment leverages machine-derived insights and is not achievable by a simple fixed-parameter inference process.

### E. Response Post-Processing and Structured Storage

The server decodes the generated token sequence into a textual response sentence. The server then performs post-processing operations, such as trimming whitespace, normalizing line breaks, and applying simple rules to segment the response into bullet points or paragraphs.

The server converts the response into response data in an output data structure, such as a record containing fields for the response text, a format type, a confidence score, and a link to the associated question record.

The server stores question data and response data in a database managed by a database management system. The server defines a schema including, for example, a table of question-and-response records with fields such as:
(1) Record identifier.
(2) User identifier.
(3) Original question text.
(4) Normalized question text.
(5) Response text.
(6) Topic label (such as crop type).
(7) Cultivation environment type.
(8) User attribute type.
(9) Timestamp of question and timestamp of response.
(10) Emotional state estimate.
(11) Prompt sentence used.

The server writes records to the storage device using transactional operations. The use of a structured schema and explicit indexing on fields such as topic label and timestamp enables efficient retrieval and large-scale aggregation, improving data management and query performance relative to conventional log-file-based storage.

### F. Emotional State Recognition and Adaptive Control

In a further embodiment, the server also receives voice data and image data from the terminal. The terminal captures these data through the microphone and camera and transmits digitized signals to the server. The server applies an acoustic feature extraction module that computes numerical features from voice data, such as Mel-frequency cepstral coefficients, fundamental frequency, energy, and prosodic patterns. The server applies an image feature extraction module that determines facial landmarks, facial expressions, and other visual cues from image data, using a convolutional neural network.

The server feeds these features into a machine learning model, such as a multi-layer perceptron or recurrent neural network, trained to estimate an emotional state label. The server then modifies the prompt sentence and model control parameters based on the estimated emotional state. For instance, when the server recognizes user frustration, the server modifies the condition description in the prompt sentence to instruct the generative AI model to provide shorter, more reassuring explanations, and adjusts the maximum generation length and the level of detail. This adaptive behavior is implemented through concrete parameter changes and template selection inside the processing pipeline, and it modifies the internal operation of the generative AI model and the server's resource scheduling strategy, thus improving response appropriateness, reducing unnecessary token generation, and lowering communication load.

### G. Data Analysis Using Embeddings and Cluster-Based Trend Detection

The server periodically analyzes the stored question-and-response data to identify high-demand fields and commercialization candidates. The server uses a data analysis module that includes:
(1) Classification processing that assigns crop type, cultivation-environment type, and user-attribute type labels to each record, using the same or an auxiliary classifier as used in the prompt construction step.
(2) Aggregation processing that computes frequencies, distributions, and co-occurrences of labels over specified time intervals.
(3) Time-series processing that detects changes in question frequencies over time, such as seasonal increases in questions about particular crops or recurring patterns for certain problems.
(4) Embedding-based clustering, in which the server converts each question or question-and-response pair into an embedding representation. The server does this by using either an embedding layer of the generative AI model or a separate embedding model such as a sentence encoder. The resulting embeddings are numerical vectors stored in the database or in a dedicated vector store.

The server applies an algorithm such as k-means clustering or hierarchical clustering to group embeddings into clusters of similar questions. The server computes cluster centroids and calculates cluster distances using a metric such as cosine distance. The server then identifies clusters with high record counts and short intra-cluster distances as high-demand fields. For each such high-demand field, the server derives commercialization candidate information, such as a continuous information-provision service, a material-provision service, or an educational-content-provision service.

This analysis is not merely a business decision process; it is implemented as a concrete computational pipeline that transforms stored natural language records into high-dimensional vectors, applies clustering algorithms, and yields structured cluster descriptors. This machine-centric process improves the technical performance of the system by enabling automatic identification of stable themes and reducing manual effort to create and maintain service configurations.

### H. Technical Advantages and Computer-Technology Improvement

The described configuration provides several technical effects beyond mere automation of human tasks.

First, by performing semantic analysis, feature extraction, and attribute estimation prior to prompt construction, the server transforms unstructured input into structured features that guide the generative AI model. This process reduces token redundancy in prompts, improves the accuracy and relevance of responses, and decreases the number of iterations needed to obtain a satisfactory answer, thereby improving processing speed and reducing resource consumption on both the server and the generative AI model hardware.

Second, by storing question-and-response data in a structured schema with explicit indices and by using embedding-based clustering, the server improves data management and query performance. The server can respond to complex analysis queries, such as “all beginner-level questions about container cultivation of a given crop over the past season”, without scanning entire log files. This leads to improved throughput for analysis tasks and lower latency for administrative queries, representing a concrete enhancement of the server's data-processing capabilities.

Third, by dynamically adjusting prompt sentences and generative AI model control parameters based on recognized attributes and emotional states, the server configures the computing resources in a non-conventional manner. The server changes internal inference parameters and prompt structures, which directly affects the number of tokens processed and generated, the convergence behavior of the decoding process, and the utilization of memory and bandwidth. This reduces unnecessary computation and network traffic and increases overall system efficiency.

Fourth, the use of a unified data pipeline, in which the same or related models are used for both response generation and embedding-based analysis, allows the server to reuse learned representations, reducing storage and model-maintenance overhead. This shared representation space improves the quality of clustering and trend detection, leading to more precise identification of user needs and fewer misclassifications, which in turn improves the stability and predictability of the system's behavior.

Fifth, the training of the generative AI model and associated classifiers uses explicit loss functions and optimization procedures. The model is trained on textual corpora and domain-specific agricultural data using a loss function such as cross-entropy, and the model weights are updated by gradient-based optimization methods, such as stochastic gradient descent or adaptive moment estimation. The training process may include data augmentation techniques, such as paraphrasing or noise injection, to improve robustness. These concrete training mechanisms produce models that are tailored to the system's operational environment and that contribute directly to the system's technical performance metrics, such as prediction accuracy and response time.

### I. Alternative Embodiments and Variations

The server may use different generative AI model architectures, such as recurrent neural networks or combinations of transformer and convolutional layers, without departing from the technical scope. The server may also deploy the generative AI model on separate hardware, such as a dedicated accelerator or cloud-based inference service, and may adjust communication protocols and data formats accordingly.

The server may employ alternative clustering algorithms, such as density-based clustering, and may store embeddings in specialized vector databases for faster similarity search. The server may also adapt the prompt construction rules to different application fields beyond agriculture by modifying template content while maintaining the overall structure of analysis-driven prompt generation.

The terminal may support additional input modalities, such as stylus input or sensor inputs, and may present responses in multimodal formats, such as text combined with images or audio. The server may convert generated text into speech using a text-to-speech engine to support audio output on the terminal.

In each embodiment, the server, the terminal, and the user interact through specific data structures and processing steps that improve computer technology by increasing processing speed, improving accuracy, reducing communication load, and enhancing data management. The combination of natural language analysis, structured prompt construction, generative AI model operation, structured storage, embedding-based clustering, and adaptive control based on emotional state provides a technical solution that cannot be achieved by simple manual procedures or conventional rule-based systems and that improves the functioning of the computer system itself.

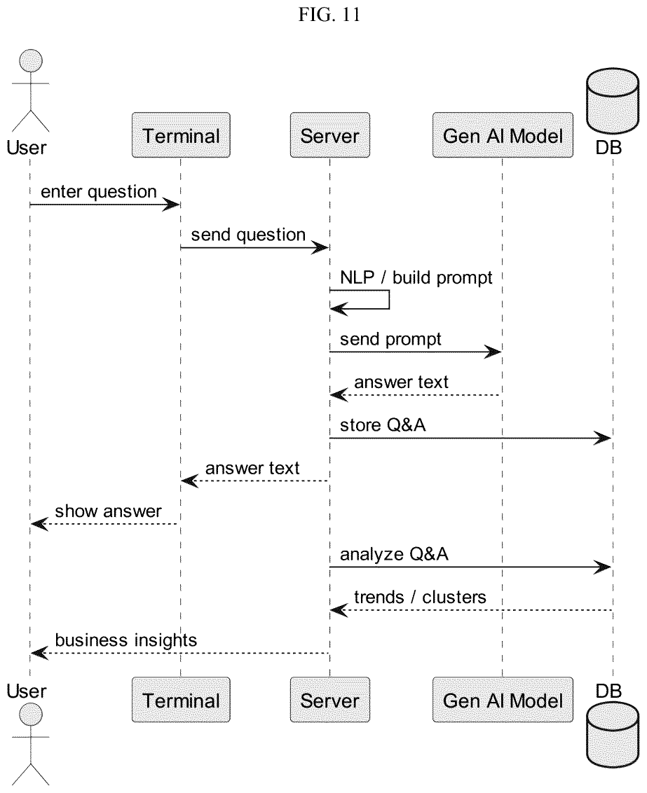

The following describes the processing flow using FIG. 11.

### Step 1:

User operates the terminal to input a natural language question.

User touches a text input field on the terminal display and types a question, for example, “Please tell me how to grow tomatoes.” The input of individual characters is converted by the terminal's input subsystem into a Unicode text string.

Input: Key events or speech captured at the terminal.

Processing: Terminal converts the raw key events or speech into a UTF-8 text string and stores it in an internal variable representing the question.

Output: A complete natural language question string held in terminal memory.

### Step 2:

Terminal sends the question string and metadata to the server.

Terminal constructs a request object that contains the question text and optional metadata (such as a local timestamp or a tentative user identifier) and encodes it into a message suitable for network transmission. Terminal then sends this message to the server via HTTPS over TCP/IP.

Input: Question string and metadata in terminal memory.

Processing: Terminal serializes the question string and metadata into a structured message, sets protocol headers, and invokes the network stack to transmit the message to the server address.

Output: A network message arriving at the server that includes the question string and metadata.

### Step 3:

Server receives the network message and decodes the question.

Server accepts the incoming HTTPS request via the network interface and HTTP server stack, decodes the message body, and reconstructs the original question string and metadata into a native data structure in main memory.

Input: Encoded network message containing the question string and metadata.

Processing: Server performs decryption, HTTP parsing, and deserialization to map the message fields into internal variables, thereby isolating the text of the question and associated metadata.

Output: A server-side question data object that contains the question text and metadata as individual fields.

### Step 4:

Server performs basic text normalization on the question.

Server cleans the received question text by normalizing whitespace, validating character encoding, and optionally converting full-width or variant characters to a canonical form.

Input: Raw question text from the question data object.

Processing: Server applies string operations and normalization rules to remove extraneous characters, unify line breaks, and standardize the representation of the question.

Output: A normalized question text string that serves as consistent input to subsequent analysis.

### Step 5:

Server applies natural language processing to extract features and attributes.

Server runs a natural language processing pipeline that tokenizes the normalized question, performs syntactic and semantic analysis, and estimates attributes such as crop type, user expertise level, and question type.

Input: Normalized question text string.

### Processing:

Server tokenizes the text into tokens using a tokenizer.
Server applies a part-of-speech tagger and parser to determine grammatical structure.
Server uses trained classifiers to assign topic labels (for example, tomato-related, balcony cultivation) and user attributes (for example, beginner).

The server converts these results into structured features, such as numeric vectors and categorical labels.

Output: A feature set and attribute set associated with the question, stored as structured data in memory.

### Step 6:

Server constructs a context-aware prompt sentence for the generative AI model.

Server uses a template that combines fixed instructional text with elements derived from the feature and attribute sets and with the original or normalized question text to create a prompt sentence.

Input: Normalized question text and the feature/attribute sets.

Processing: Server selects an appropriate template (for example, “beginner-level explanation template”), inserts inferred context phrases (such as “novice home gardener” or “container cultivation”), and concatenates these components into a single prompt sentence.

Output: A constructed prompt sentence string that encodes both the user's question and analysis-derived context.

### Step 7:

Server prepares the generative AI model input based on the prompt sentence.

Server converts the prompt sentence into tokens and arranges them in the input format required by the generative AI model, including any control parameters such as temperature, maximum output length, and sampling mode.

Input: Prompt sentence string and configuration parameters.

Processing: Server runs a tokenizer to map the prompt sentence into a sequence of token identifiers, and then encapsulates the token sequence and parameters into a model input object.

Output: A model input object containing tokenized prompt data and generation control parameters.

### Step 8:

Server executes the generative AI model to generate a response.

Server invokes the generative AI model, which uses a transformer-based neural network to compute probabilities for successive output tokens and to generate a response sentence.

Input: Model input object with tokenized prompt and control parameters.

### Processing:

Server feeds the token sequence into the embedding layer and then through multiple attention and feedforward layers implemented on numerical hardware.
Server iteratively samples or selects the next token based on computed probability distributions, appending each selected token to a generation buffer until a termination condition is met.

Output: A generated token sequence that represents the content of the response.

### Step 9:

Server decodes the generated token sequence into a response sentence and applies post-processing.

Server converts the generated tokens back into a text string and refines the output for readability and format consistency.

Input: Generated token sequence from the generative AI model.

Processing: Server runs the tokenizer's decode function to obtain a plain text response, then applies rules for trimming whitespace, organizing text into sentences or bullet points, and removing unintended artifacts.

Output: A finalized response sentence string suitable for display to the user.

### Step 10:

Server creates a structured question-and-response record.

Server combines the normalized question, the response sentence, the feature and attribute sets, the prompt sentence, and timing information into a record that conforms to the database schema.

Input: Normalized question text, response sentence string, feature/attribute sets, prompt sentence, and metadata including timestamps and identifiers.

Processing: Server assembles these data elements into a structured record object with defined fields and prepares it for insertion into persistent storage.

Output: A structured record object representing a single question-and-response interaction.

### Step 11:

Server stores the question-and-response record in the database.

Server writes the structured record into the database, associating it with appropriate indices for later retrieval and analysis.

Input: Structured question-and-response record object.

Processing: Server generates and executes a database insertion command that maps record fields to columns in a database table and commits the transaction to ensure durability.

Output: A stored database row or entry representing the interaction, accessible by queries based on identifiers, timestamps, or labels.

### Step 12:

Server transmits the response sentence back to the terminal.

Server encapsulates the response sentence and optionally related metadata into a response message and sends it over the network to the terminal.

Input: Finalized response sentence and any response metadata.

Processing: Server serializes the response into a structured message, sets appropriate headers, and uses the network interface to transmit the message via HTTPS to the terminal address.

Output: A network response message containing the response sentence, delivered to the terminal.

### Step 13:

Terminal receives the server response and extracts the answer.

Terminal decodes the received message and retrieves the response sentence for display.

Input: Network response message from the server.

Processing: Terminal performs protocol parsing and deserialization to convert the message back into internal variables, then selects the field storing the response sentence.

Output: A response text string stored in terminal memory, ready to be rendered on the display.

### Step 14:

Terminal displays the response to the user.

Terminal renders the response sentence on the display using its user interface components so that the user can read the generated answer.

Input: Response text string in terminal memory.

Processing: Terminal updates the graphical user interface by drawing the response text in a designated area using the rendering engine and font resources.

Output: A visible text answer shown on the terminal screen, which the user can visually perceive.

### Step 15:

Server periodically retrieves stored records for analysis.

Server accesses the database to obtain multiple question-and-response records for aggregate processing and trend detection.

Input: Database table containing stored question-and-response records.

Processing: Server executes queries to select records based on time ranges, topic labels, user attributes, or other criteria, and loads the selected records into main memory as a dataset.

Output: An in-memory dataset consisting of multiple structured records for analysis.

### Step 16:

Server performs classification, aggregation, and time-series analysis on the dataset.

Server processes the in-memory dataset to compute frequencies, distributions, and temporal patterns across different categories.

Input: Dataset of structured question-and-response records.

### Processing:

Server groups records by fields such as crop type, cultivation environment, and user attribute type.
Server calculates counts, averages, and trends over time intervals for each group.
Server identifies patterns such as increasing question frequency for particular topics.

Output: Aggregated metrics and time-series summaries for different categories of questions and responses.

### Step 17:

Server generates embedding representations and clusters questions into high-demand fields.

Server converts each question or question-and-response pair into a numeric embedding vector and groups similar vectors into clusters that represent coherent topics or demand areas.

Input: Selected text fields from the dataset, such as normalized questions and responses.

### Processing:

Server feeds text into an embedding model or into an embedding-generating part of the generative AI model to obtain vectors.
Server applies a clustering algorithm to group vectors based on similarity, calculates cluster centroids, and measures cluster densities and distances.

Output: A set of clusters, each with an associated group of records, centroid embeddings, and demand-related statistics.

### Step 18:

Server derives commercialization candidate information from the clusters.

Server interprets the cluster properties to identify high-demand fields and maps them to potential services or products to be managed by administrators.

Input: Cluster definitions, demand statistics, and category labels from prior analysis.

### Processing:

Server identifies clusters that exceed defined thresholds in size or growth rate.
Server associates each such cluster with candidate service types, such as continuous information-provision services or educational-content-provision services.
Server formats these results as commercialization candidate information records.

Output: A set of commercialization candidate information records that summarize high-demand fields and recommended service types.

### Step 19:

Server provides commercialization candidate information to an administrator interface.

Server outputs the commercialization candidate information to an administrative terminal or dashboard so that human administrators can review and, if desired, configure new services.

Input: Commercialization candidate information records.

Processing: Server prepares visualization-ready data, such as charts or lists, and sends it to an administrator terminal or renders it on a server-side interface.

Output: Displayable administrative information that presents machine-derived commercialization candidates, enabling informed configuration and management of services based on the analyzed interaction data.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional question-answering systems for agricultural support typically rely on fixed rule-based logic, manually curated knowledge bases, or simple retrieval of pre-authored answers. Such systems suffer from several technical limitations. First, they have limited capability to interpret diverse, noisy user inputs, particularly when the inputs are provided as spontaneous speech in an outdoor environment with background noise, resulting in frequent recognition errors and mismatches between user intent and system response. Second, they do not effectively coordinate multiple heterogeneous components, such as speech recognition engines, generative AI models, and speech synthesis engines, in a tightly integrated processing pipeline; this leads to increased latency, inefficient use of computational resources, and inconsistent behavior across different devices and network environments. Third, conventional systems generally lack a structured mechanism to accumulate and analyze large-scale interaction logs (e.g., question-answer pairs) from field operations, and therefore cannot technically optimize model prompting, response generation, and system performance based on actual usage in agricultural workflows.

Furthermore, existing architectures often handle audio acquisition, natural language understanding, answer generation, and audio output as loosely coupled subsystems, without a unified control flow executed by a single processor. This fragmented architecture makes it difficult to systematically generate prompt sentences tailored to agricultural work, to dynamically adjust prompts or responses based on user state, and to provide low-latency, hands-free interaction from terminals mounted on agricultural work machines. As a result, system responsiveness is degraded, the accuracy and relevance of responses are inconsistent, and the overall computing system fails to provide reliable real-time support in the harsh and time-critical environments typical of agricultural operations.

Accordingly, there is a need for an improved computer-implemented system in which a processor centrally orchestrates: (i) acquisition of user voice questions from a terminal; (ii) conversion of audio data into character data via a speech recognition apparatus; (iii) generation of structured prompt sentences that include both user questions and domain-specific response policies; (iv) invocation of a generative AI model to produce optimized response sentences; (v) storage and analysis of question-answer correspondence relationships in a storage device; and (vi) conversion of responses back into synthesized audio for real-time output on agricultural machinery. By redesigning the processing pipeline and data flows among these components, the underlying computer technology can be improved in terms of robustness, latency, adaptability, and scalability in field-deployed agricultural support systems.

The specific processing by the specific processing unit 290 of the data processing device 12 in Application Example 1 is realized by the following means.

The present invention provides a server comprising a processor configured to receive, from a terminal including an input/output device and a communication device, audio data representing a voice question spoken by a user; to transmit the audio data to a speech recognition information processing apparatus and obtain, based on the audio data, character data representing a question sentence from the user; to generate a prompt sentence including the question sentence and an instruction sentence indicating a response policy related to agricultural work, and to input the prompt sentence to a generative information processing model to cause the generative information processing model to generate a response sentence related to the agricultural work; to store, in a storage device, information including the question sentence and the response sentence, thereby accumulating a correspondence relationship between questions and responses; to transmit the response sentence to a speech synthesis information processing apparatus and obtain synthesized audio data based on the response sentence; to transmit the synthesized audio data to the terminal and cause the terminal to present the response to the user via an acoustic output device of the terminal; and to analyze the accumulated correspondence relationship between questions and responses stored in the storage device and generate an analysis result for evaluating a possibility of business development related to support for agricultural work. This enables an integrated computer-implemented pipeline in which heterogeneous recognition, generation, storage, and synthesis components are orchestrated by the processor in a technically improved manner, resulting in more accurate interpretation of user voice input, more context-appropriate prompt sentences for the generative AI model, reduced end-to-end response latency, and adaptive optimization of system behavior based on large-scale interaction data collected from agricultural work environments.

The term “system” refers to an arrangement of one or more computing devices, storage devices, and communication devices that cooperate to execute the processing described in the claims.

The term “processor” refers to one or more hardware processing units, such as a central processing unit or a microcontroller, configured to execute instructions and control data processing operations described in the claims.

The term “terminal” refers to an information processing device including at least an input/output device and a communication device, and being capable of transmitting data to and receiving data from the server.

The term “input/output device” refers to a component of the terminal configured to receive input from a user and to present output to the user, including at least one of a microphone, a speaker, a display, a touch panel, or physical buttons.

The term “communication device” refers to a hardware and software component of the terminal or server configured to send and receive data over a communication network, such as a wired or wireless network interface.

The term “audio data” refers to digital data representing a time-series audio signal, including a sampled and quantized representation of a voice utterance spoken by a user.

The term “voice question” refers to a question expressed by the user as spoken language and captured as audio data by the terminal.

The term “user” refers to a person operating or interacting with the terminal, including but not limited to a worker performing agricultural work.

The term “speech recognition information processing apparatus” refers to a computing resource, including hardware and software, configured to convert audio data into character data using speech recognition processing.

The term “character data” refers to digital data representing textual information encoded as a sequence of characters, symbols, or tokens.

The term “question sentence” refers to a text string in the character data that represents a question expressed by the user, obtained through speech recognition.

The term “instruction sentence” refers to a text string that specifies a response policy, constraints, or guidelines for generating a response related to agricultural work.

The term “response policy” refers to a set of rules, criteria, or preferences that guide content, style, or level of detail of a response sentence related to agricultural work.

The term “prompt sentence” refers to a data structure or text string that includes at least the question sentence and the instruction sentence, and that is supplied as input to a generative information processing model to control generation of a response sentence.

The term “generative information processing model” refers to a computational model, such as a generative AI model or a large language model, configured to generate text output based on input data including a prompt sentence.

The term “response sentence” refers to a text string generated by the generative information processing model, representing an answer or guidance related to the question sentence and agricultural work.

The term “storage device” refers to a memory device, such as a non-volatile storage or a database system, configured to store information including question sentences, response sentences, and associated metadata.

The term “correspondence relationship between questions and responses” refers to an association stored in the storage device that links each question sentence with at least one corresponding response sentence.

The term “speech synthesis information processing apparatus” refers to a computing resource, including hardware and software, configured to convert text such as the response sentence into synthesized audio data using speech synthesis processing.

The term “synthesized audio data” refers to digital audio data generated from text, representing a synthetic voice output of the response sentence.

The term “acoustic output device” refers to a component, such as a speaker or headset, configured to convert synthesized audio data into audible sound for presentation to the user.

The term “analysis result” refers to information generated by processing the accumulated correspondence relationships between questions and responses, indicating patterns, metrics, or evaluations including a possibility of business development related to support for agricultural work.

The term “business development related to support for agricultural work” refers to planning, designing, or offering services or products that utilize analysis of stored interactions to improve or expand support for agricultural operations.

The term “emotional state” refers to a psychological condition of the user, such as frustration, satisfaction, confusion, or urgency, inferred from analysis of audio data, image data, or other user-related signals.

The term “audio data of the user” refers to sound information captured from the user, including speech signals used for emotion recognition as well as for question input.

The term “image data of the user” refers to digital image or video data that includes at least a part of the user, and that can be used to analyze facial expressions or gestures.

The term “agricultural work machine” refers to a machine or vehicle used for performing agricultural tasks, such as tilling, planting, harvesting, or spraying, and capable of being equipped with the terminal.

The term “real time” refers to processing and output performed with a latency sufficiently low that the user can receive a response during or immediately after the corresponding operation, such that the interaction appears instantaneous or nearly instantaneous in the context of agricultural work.

In one embodiment, a server cooperates with a terminal mounted on an agricultural work machine to implement an agricultural support system using a generative AI model. The server includes at least one processor, a main memory, a non-volatile storage device, and a network interface. The terminal includes at least one processor, a memory, an audio input device such as a microphone, an acoustic output device such as a speaker, and a wireless communication device. The user operates the agricultural work machine and interacts with the system through the terminal using voice input and audio output.

The server executes an operating system such as a general-purpose server operating system and runs one or more application programs implementing: (i) a speech recognition client, (ii) a prompt sentence generator, (iii) a client for a generative AI model, (iv) a logging and storage module, (v) a speech synthesis client, and (vi) an analysis module. In one embodiment, the server uses a cloud-based speech recognition service such as a generic speech-to-text API, a cloud-based text-to-speech service such as a generic text-to-speech API, and a generative AI model such as a transformer-based large language model made available through a network-accessible inference endpoint. The terminal executes an embedded operating system such as an embedded Linux or mobile operating system and runs a communication client and an audio input/output control program.

The terminal acquires analog voice signals from the microphone and converts the analog signals into digital audio data using an analog-to-digital converter. The terminal processor stores the digital audio samples in a buffer in memory. The terminal compresses the audio data using a codec, for example by encoding 16-bit linear PCM data sampled at 16 kHz into a compressed format such as FLAC. The terminal then transmits the compressed audio data to the server using an application-layer protocol over a wireless network, leveraging the terminal's communication device.

The server receives the audio data and stores it in a buffer in the main memory. The server then calls a speech recognition information processing apparatus. In one embodiment, the speech recognition apparatus is implemented as a remote cloud service providing an API that accepts the audio data and returns recognition results. The server transmits the audio data together with parameters specifying an audio encoding format, sampling rate, and language code. The speech recognition apparatus applies signal processing algorithms, such as short-time Fourier transform and feature extraction (e.g., Mel-frequency cepstral coefficients), followed by acoustic modeling and language modeling using a neural network architecture, and outputs character data representing the recognized text. The server receives the recognition result as structured data (e.g., a list of candidate transcriptions with confidence scores), selects the top-ranked transcription, and stores a question sentence as a text string in memory and in a storage device.

The server generates a prompt sentence for a generative AI model. The server stores in the storage device a set of instruction templates corresponding to different agricultural domains (for example, fertilizer selection, disease diagnosis, pest control, and machine operation). The server selects one instruction template based on metadata associated with the terminal, such as the type of agricultural work machine, the crop type supplied by the user at system setup, or a configuration parameter. The server concatenates the instruction template and the question sentence to form a prompt sentence. For example, the server may generate the following prompt sentence:

“You are an agricultural support assistant. Answer farmers' questions clearly and concisely in Japanese. Focus on practical field operations, fertilizer usage, pest control, and safe machine operation. The user's question is: What fertilizer is suitable for this crop?”

In another example related to crop disease, the server may generate a prompt sentence:

“You are an agricultural support assistant. Provide accurate and practical advice in Japanese on crop diseases, fertilizers, and pest control. Generate an appropriate response to the following question about crop disease: “There are black spots on my tomato leaves. What should I do?”

The server supplies the prompt sentence to a generative AI model. In one embodiment, the generative AI model is a transformer-type neural network having multiple encoder-decoder or decoder-only layers, multi-head self-attention mechanisms, and feedforward layers. The model has been pre-trained on large-scale text corpora and fine-tuned on domain-specific agricultural data. The server tokenizes the prompt sentence into subword tokens using a predetermined tokenizer, maps each token to an embedding vector, and forwards the embedding sequence to the generative AI model. Within the model, attention heads compute weighted combinations of token embeddings using learned attention weights, feedforward networks apply non-linear transformations, and layer normalization stabilizes the intermediate representations. The model outputs a probability distribution over possible next tokens at each position. The server or the model's inference engine selects output tokens using a decoding strategy such as greedy decoding or top-k sampling, subject to constraints such as maximum length and temperature parameters.

The generative AI model performs data operations that are not reducible to a simple deterministic rule engine. The model uses distributed representations and long-range dependencies encoded in attention weights to infer context and generate a response sentence that is sensitive to agricultural constraints, such as soil conditions, weather, machinery availability, and safety considerations. The server receives the generated tokens from the model, reconstructs a text string as the response sentence, and optionally normalizes the output (for example, by correcting spacing or punctuation).

The server stores interaction data in a storage device, such as a relational database system or a key-value store. The server creates a data structure, for example a record with fields including: a terminal identifier, a timestamp, the recognized question sentence, the prompt sentence used for generation, the generated response sentence, and context metadata such as GPS coordinates of the agricultural work machine or an identifier of the field. The server writes this record to a table or collection and maintains appropriate indexes on columns such as timestamp, terminal identifier, and keyword features extracted from the question sentence.

The server uses this structured storage to perform efficient retrieval and analysis of past question-answer pairs.

The server invokes a speech synthesis information processing apparatus to transform the response sentence into synthesized audio data. In one embodiment, the speech synthesis apparatus is a cloud-based text-to-speech service using a neural network TTS model, such as a sequence-to-sequence model or a neural vocoder model. The server transmits the response sentence along with parameters indicating the language, desired speaking rate, intonation profile, and audio encoding. The TTS model converts the text into a sequence of phonetic units, predicts spectrogram frames using a recurrent or transformer-based network, and generates a waveform from the spectrogram using a neural vocoder. The server receives synthesized audio data, for example as an array of PCM samples or an encoded audio file.

The server transmits the synthesized audio data to the terminal through the network interface. The terminal receives the audio data, decodes it if necessary, and supplies the audio samples to a digital-to-analog converter. The terminal outputs the audio through the speaker installed in the cabin of the agricultural work machine. The user hears the response in real time while operating the machine and can adjust work activities accordingly, such as changing fertilizer application rates or taking immediate measures against a suspected disease.

In one embodiment, the server analyzes the accumulated question-answer correspondence relationships stored in the storage device. The server computes statistical features such as frequency of certain keywords in question sentences, distribution of response categories, and temporal patterns of similar questions. The server may cluster question sentences using vector representations derived from an embedding model and maintain a cluster index. This analysis allows the server to refine the instruction templates used in prompt sentence generation. For example, if the server detects that many questions relate to a specific crop disease, the server updates the instruction sentence to bias the generative AI model to produce more detailed and precise content for that disease. This feedback loop, implemented as changes in stored templates and model parameters, improves the accuracy and relevance of generated responses and constitutes an improvement in the functioning of the computer system.

In another embodiment, the server uses an emotion recognition function. The server receives audio data and image data of the user from the terminal. The server extracts acoustic features such as pitch, energy, and spectral tilt from the audio, and facial features such as facial landmarks and action units from image data. The server feeds these features into a trained classifier, such as a multi-layer neural network, to estimate the user's emotional state (e.g., confusion, urgency, frustration). Based on this emotional state, the server modifies parameters in the prompt sentence, for example by changing the instruction sentence to request more step-by-step explanations or to provide reassurance. The server thus adjusts the generative AI model's output style algorithmically, using technical signals derived from sensor data, and not merely by human judgment.

The server improves computer technology in several ways. By coordinating speech recognition, prompt sentence generation, generative AI inference, storage, analysis, and speech synthesis within a centralized processing architecture, the server reduces end-to-end latency and communication overhead. For example, the server compresses audio before transmission, batches calls to remote services, and caches recognition results for repeated phrases. The server uses specialized data structures for logs and indexes, enabling sub-second retrieval and matching of similar past questions, which can be used to adapt prompts or to provide fallback answers when network conditions are poor. The server also improves accuracy by learning from large volumes of field data: the server adjusts prompt sentence templates, fine-tunes model parameters on anonymized question-answer pairs, and optimizes hyperparameters such as decoding temperature based on observed performance metrics.

These adjustments are executed by the server through automated procedures, such as gradient descent-based fine-tuning routines and heuristic optimization algorithms, rather than by manual human tuning.

The terminal configuration also contributes to technical effects. Because the terminal is mounted on an agricultural work machine, the terminal can integrate sensor data such as vehicle speed, engine load, or implement status. The terminal transmits this sensor data as metadata to the server. The server uses this metadata to condition the prompt sentence, for instance by including in the instruction sentence a request for responses that account for the current operation mode of the machine. This linkage between machine-state data and natural language generation alters internal computation within the generative AI model, leading to different attention patterns and output distributions, and results in more context-aware advice. In this way, the system goes beyond generic question answering and provides a specific technical improvement in controlling and supporting field machinery operation.

In one alternative embodiment, the server partially executes the speech recognition and speech synthesis locally using dedicated hardware accelerators, such as digital signal processors or graphics processing units. The server hosts a compact end-to-end speech recognition network, for example a convolutional-recurrent or transformer-based acoustic model, and a compact neural vocoder. By performing inference on these local models, the server reduces external network calls to remote services, thereby reducing communication latency and bandwidth consumption. The server selects between local and remote services based on network conditions, CPU load, or quality-of-service requirements, which is implemented as a dynamic routing algorithm executed by the server.

In another embodiment, the generative AI model is deployed on the server itself rather than as a remote service. The server stores model parameters in a high-performance storage hierarchy and loads frequently used layers into GPU memory to accelerate inference. The server segments the model across multiple processing units and uses parallel processing strategies such as model parallelism and pipeline parallelism. The server quantizes model weights to reduced precision formats to lower memory footprint and improve inference speed while controlling degradation in answer quality. These design choices directly improve computational efficiency and enable real-time responses in the agricultural environment, where network connectivity can be unstable.

The system described above is not limited to one specific agricultural machine or network configuration. The server can cooperate with different types of terminals, including handheld devices used by workers on foot, wearable devices such as headsets, or fixed terminals installed in agricultural facilities. Variations in hardware and communication protocols can be accommodated by adjusting the audio encoding, communication protocol, and local buffering behavior at the terminal. The core processing architecture on the server side-speech recognition, prompt sentence generation, generative AI processing, structured storage, analysis, and speech synthesis-remains substantially the same, thereby providing a consistent improvement in the underlying computer technology across various deployment scenarios.

Through these embodiments, the server, the terminal, and the user cooperate to implement a technically specific and improved computation pipeline that uses a generative AI model and carefully constructed prompt sentences to support agricultural work. The improvements are realized in the internal operation of the computing system-enhanced speech recognition and generation accuracy, optimized data structures for interaction logs, adaptive prompt sentence generation linked to real-time machine and user state, and reduced latency and communication load-rather than merely automating human mental processes.

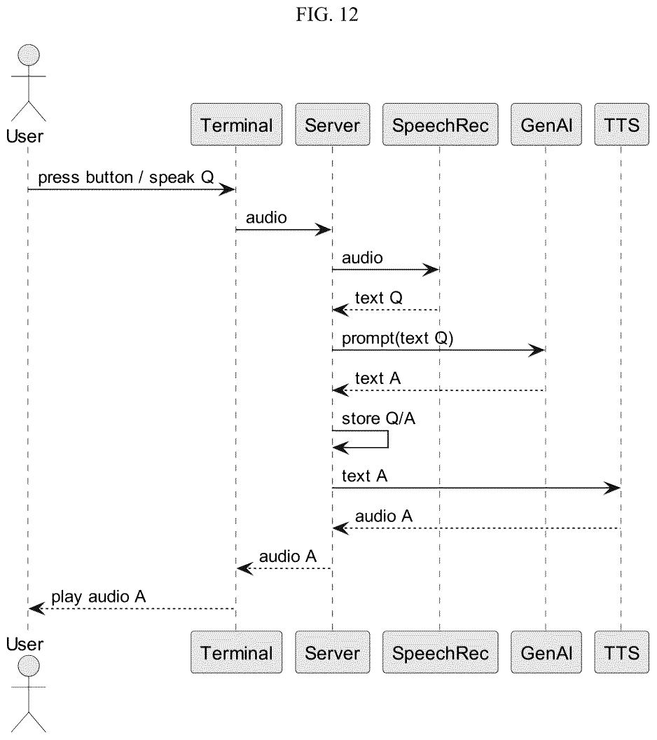

The following describes the processing flow using FIG. 12.

### Step 1:

The user provides a voice question to the terminal.

The user presses a start-input control (for example, a physical button or a touch icon) on the terminal mounted on an agricultural work machine and speaks a question, such as “What fertilizer is suitable for this crop?”. The terminal receives analog voice signals from a microphone as input. The terminal converts the analog signals into digital audio samples using an analog-to-digital converter, performs buffering in memory, and optionally encodes the samples into a compressed format such as FLAC or linear PCM with a header. The terminal outputs a block of digital audio data representing the user's voice question.

### Step 2:

The terminal transmits the digital audio data to the server.

The terminal takes the digital audio data as input, attaches metadata such as a terminal identifier, timestamp, and language code, and packages them into a request message. The terminal performs data processing that includes creating a network packet sequence and applying a transport protocol (for example, TCP) and an application protocol (for example, HTTPS). Based on the audio data and metadata, the terminal outputs an encrypted network request that is sent via a wireless communication device to the server.

### Step 3:

The server receives the audio request and prepares it for speech recognition.

The server takes the network request as input and decodes it using a communication stack.

The server extracts the audio payload and the associated metadata from the request body, verifies integrity (for example, by checking a length field or checksum), and stores the audio data in a memory buffer. The server outputs a normalized audio data object with known encoding parameters (such as sampling rate and bit depth) that will be used as input to a speech recognition information processing apparatus.

### Step 4:

The server converts the audio data into a question sentence using speech recognition.

The server sends the normalized audio data as input to a speech recognition information processing apparatus, specifying parameters such as language code and audio encoding. The speech recognition apparatus applies data processing that includes feature extraction (for example, Mel-frequency cepstral coefficients), acoustic modeling using a neural network, and decoding using a language model. Based on these operations, the apparatus outputs character data representing one or more candidate transcriptions. The server receives these candidates, selects the transcription with the highest confidence score, and outputs a question sentence as a text string, such as “What fertilizer is suitable for this crop?”

### Step 5:

The server generates a prompt sentence for a generative AI model.

The server takes the question sentence and stored instruction templates as input. The server performs text concatenation and template filling: it selects a suitable instruction sentence for agricultural support (for example, “You are an agricultural support assistant. Answer farmers' questions clearly and concisely in Japanese. Focus on practical field operations, fertilizer usage, pest control, and safe machine operation.”), and inserts the question sentence into a predefined prompt structure. The server outputs a complete prompt sentence such as “You are an agricultural support assistant. Answer farmers' questions clearly and concisely in Japanese. Focus on practical field operations, fertilizer usage, pest control, and safe machine operation. The user's question is: What fertilizer is suitable for this crop?”

### Step 6:

The server invokes the generative AI model using the prompt sentence.

The server takes the prompt sentence as input and calls a generative AI model endpoint. Internally, the endpoint tokenizes the prompt sentence into subword tokens, embeds each token into a vector, and processes the sequence through a transformer architecture including multi-head self-attention and feedforward layers. The model applies data computations such as matrix multiplications, non-linear activations, and probability normalization to predict a distribution over next tokens at each step. Based on these computations, the generative AI model outputs a sequence of tokens that form a response. The server decodes these tokens into text and outputs a response sentence, for example “This crop responds well to nitrogen-rich fertilizers. Based on soil test results, apply balanced amounts of fertilizers containing phosphorus and potassium as well.”

### Step 7:

The server stores the question-answer pair and related metadata.

The server takes as input the question sentence, the prompt sentence, the response sentence, and metadata such as terminal identifier, timestamp, and location information. The server constructs a database record by mapping each item into corresponding fields (for example, question_text, prompt_text, answer_text, device_id, created_at). The server performs data operations such as generating an SQL INSERT statement or building a document for a NoSQL store, and then writes the record into a storage device. As output, the server maintains an updated collection of stored correspondence relationships between questions and responses, which can be later accessed for analysis and optimization.

### Step 8:

The server converts the response sentence into synthesized audio data.

The server takes the response sentence as input and transmits it to a speech synthesis information processing apparatus, along with parameters specifying language, voice type, and audio format. The speech synthesis apparatus performs text processing to derive phoneme sequences, predicts acoustic features such as spectrogram frames using a neural network model, and synthesizes waveform samples using a neural vocoder. From these computations, the apparatus outputs synthesized audio data representing a spoken version of the response sentence. The server receives this audio data, optionally adds a short leading and trailing silence, and outputs a finalized audio stream formatted for transmission to the terminal.

### Step 9:

The server sends the synthesized audio data to the terminal.

The server takes the finalized audio stream as input and packages it into a network response message. The server adds appropriate headers (such as content type and length), encrypts the payload if required, and transmits the message through its network interface. As output, the server produces an outgoing network response that carries the synthesized audio data destined for the terminal.

### Step 10:

The terminal receives and plays back the synthesized audio for the user.

The terminal takes the incoming network response as input, decodes the protocol headers, and extracts the synthesized audio data. The terminal performs any necessary decoding (for example, MP3 or other codec decoding) and writes the resulting audio samples to an audio buffer. The terminal supplies the samples to a digital-to-analog converter, which generates analog signals that are sent to the speaker. As output, the terminal produces audible sound corresponding to the response sentence, allowing the user to hear instructions such as “This crop benefits from nitrogen-rich fertilizer. Check the soil test results and supplement with phosphorus and potassium as needed.”

### Step 11:

The server analyzes stored interaction data to improve future processing.

The server takes stored question-answer records as input from the storage device. The server computes statistics such as term frequencies, clustering of similar questions using vector embeddings, and distributions of answer categories. Based on these data operations, the server adjusts internal parameters, for example by updating instruction templates used in prompt sentences, tuning decoding parameters (such as temperature), or selecting specialized prompt patterns for frequently observed question types. The server outputs updated configuration data that is used in future executions of Steps 5 and 6, thereby improving response relevance and computational efficiency over time.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional question-answering systems for agricultural support often rely on static rule sets or simple retrieval of pre-authored guidance documents. Such systems suffer from several computer-technical deficiencies. First, they are not architected to systematically convert heterogeneous expert data into optimized training data for a generative AI model, resulting in inefficient use of processing resources and suboptimal response quality. Second, existing architectures typically pass raw or minimally processed user questions directly to a model, without structured extraction of key attributes such as target crop, cultivation conditions, and problem type, which leads to unnecessarily long inputs, higher computational load, and unstable response behavior on a computer. Third, most systems do not integrate stored question-and-answer records into the model input through similarity-based retrieval and extended prompt construction, which fails to exploit available data structures in storage devices and increases redundant computation by the model.

Moreover, conventional systems lack mechanisms at the processor level to dynamically refine model inputs and outputs based on the user's emotional state, resulting in repeated, unnecessary inference calls or overly detailed or overly terse responses that waste computing cycles and network bandwidth. Additionally, stored interaction records are rarely analyzed in a structured, machine-executable manner to guide retraining data selection and model parameter tuning, so the learning pipeline does not adapt efficiently to actual usage patterns. This leads to an inefficient training workflow, unnecessary training on low-value data, and degraded scalability of the system when deployed on computing infrastructure.

Accordingly, there is a need for an improved computer-implemented system that: (i) normalizes and semantically analyzes user questions to produce compact, attribute-rich prompt sentences for a generative AI model; (ii) constructs and maintains structured training data from expert guidance and historical interactions to optimize generative model parameters; (iii) performs similarity-based retrieval over stored records to form extended input data that reduces redundant computation while improving response relevance; and (iv) uses analytics on stored records and user emotion recognition to adapt both inference behavior and retraining strategies in a way that improves overall computer system performance, including response accuracy, processing efficiency, and resource utilization.

The specific processing by the specific processing unit 290 of the data processing device 12 in Example 2 is realized by the following means.

The present invention provides a server comprising a processor configured to expose, via an information input/output device of a terminal, a user interface implemented as executable instructions stored in a memory and executed by the processor, the user interface being configured to receive natural language question sentences related to an agricultural field from a user and to provide the question sentences to the processor as input data; to preprocess the input data by executing, by the processor, character normalization, removal of unnecessary symbols, and length constraint checking on the input data, and to apply syntactic analysis and semantic analysis using a natural language processing algorithm to extract attribute information including at least a target crop, a cultivation environment condition, and a problem type, and to generate a prompt sentence including the attribute information and convert the prompt sentence into an input format of a generative AI model executable on the server; to collect, via communication circuitry, guidance data including expert knowledge from one or more external information sources, transform the guidance data into a structured training data set representing correspondences between question sentences and answer sentences, and train the generative AI model by causing the processor to execute a machine learning framework that optimizes parameters of the generative AI model based on the training data set; to generate extended input data by performing, on stored question-and-answer records and expert knowledge data held in a storage device, similarity-based retrieval using feature vectors derived from the prompt sentence, selecting one or more past question-and-answer records and expert data portions having similarity above a predetermined threshold, and appending selected content to the prompt sentence; to perform inference processing by providing the extended input data to the generative AI model and causing the processor to sequentially generate, using the generative AI model, response candidates and output a response sentence as natural language text; to postprocess the response sentence by executing unit conversion, expression unification, and structuring of important items to generate response information including at least a crop name, a recommended temperature range, a recommended humidity range, and a soil acidity range, and to transmit the response information to the terminal for presentation to the user; to store, in the storage device, question sentences and response sentences as records including at least question text, answer text, crop attributes, and time information, and to execute aggregation processing and similarity calculation processing on a plurality of the records to generate analysis data indicating at least selection criteria for retraining data and business candidate information related to service provision and additional knowledge modules; and optionally to perform, by executing instructions on the processor, emotion recognition based on audio signals and image signals associated with the user to estimate an emotional state and adjust at least an expression intensity, an explanation level, and advice content of the response sentence in accordance with the emotional state. This enables the server to improve computer functionality by reducing unnecessary model input length and computation, by leveraging structured retrieval and training data selection to enhance generative AI model performance, by adaptively controlling inference and retraining behavior based on stored interaction analytics and user state, and by thereby providing more accurate and efficient responses using fewer computational resources.

The term “system” refers to a combination of one or more computing devices, storage devices, communication interfaces, and software components that cooperate to perform the processing described in the claims.

The term “processor” refers to one or more hardware processing units, such as a central processing unit, a graphics processing unit, or a specialized accelerator, configured to execute instructions and perform arithmetic and logic operations.

The term “memory” refers to any volatile or non-volatile storage medium, such as random access memory or read-only memory, that stores instructions and data for access by the processor.

The term “storage device” refers to a non-volatile information storage apparatus, such as a magnetic disk drive, a solid state drive, or a non-volatile semiconductor memory, that stores data including records, models, and logs.

The term “communication circuitry” refers to hardware and associated control logic for transmitting and receiving data over a wired or wireless communication network.

The term “terminal” refers to an electronic computing device operated by a user, such as a mobile device, a tablet device, or a personal computer, that provides an interface to the system.

The term “information input/output device” refers to hardware associated with the terminal, including a display, a touch panel, a keyboard, a pointing device, a microphone, a camera, and related controllers, which enable input from and output to the user.

The term “user interface” refers to a software-controlled presentation and control layer, including screens, dialog boxes, and interactive elements, through which the user inputs data and receives information.

The term “user” refers to a human operator who interacts with the terminal and the system by providing questions and consuming responses.

The term “natural language question” refers to a text sequence expressed in a human language, such as a sentence or phrase, input by the user to request information or advice.

The term “question sentence” refers to a natural language string formatted as a query, including interrogative expressions or imperative requests for information.

The term “input data” refers to data received by the processor from the user interface or from another component, including at least the natural language question and associated metadata.

The term “preprocessing” refers to a set of operations performed on input data before analysis or inference, including at least character normalization, removal of unnecessary symbols, and checking of length constraints.

The term “character normalization” refers to converting characters in a text into a standardized representation, including unifying character encodings, normalizing case, and harmonizing full-width and half-width forms.

The term “removal of unnecessary symbols” refers to deleting or replacing symbols, control characters, or markup elements that are not needed for semantic interpretation or modeling.

The term “length constraint checking” refers to verifying that the length of a text, measured in characters, tokens, or bytes, is within predetermined minimum or maximum limits.

The term “natural language processing algorithm” refers to a computerized method that analyzes natural language text, including parsing, tagging, and understanding, implemented in software executed by the processor.

The term “syntactic analysis” refers to processing that identifies grammatical structure of a sentence, such as parts of speech and dependencies among words.

The term “semantic analysis” refers to processing that interprets the meaning of a sentence, including identifying entities, relationships, and intent.

The term “attribute information” refers to structured data elements extracted from input data, such as a target crop, a cultivation environment condition, and a problem type.

The term “target crop” refers to an agricultural plant type indicated in a question, such as a vegetable, fruit, grain, or other cultivated plant.

The term “cultivation environment condition” refers to a parameter related to an environment in which a crop is grown, including at least temperature, humidity, soil condition, light condition, or geographic characteristic.

The term “problem type” refers to a classification of an issue described in a question, including at least disease, pest damage, nutrient deficiency, irrigation problem, or environmental stress.

The term “prompt sentence” refers to a text sequence constructed by the system that encodes a question and associated attribute information, formatted as an input to a generative AI model.

The term “input format of a generative AI model” refers to a representation of data, including token sequences, special markers, and tensors, that conforms to the input requirements of a generative AI model implementation.

The term “generative AI model” refers to a trainable computational model, such as a neural network or transformer-based model, configured to generate natural language text in response to input data.

The term “guidance data” refers to information obtained from expert sources, documents, or databases that includes domain-specific knowledge and procedural descriptions for agricultural practice.

The term “expert knowledge” refers to information derived from persons or organizations with specialized experience or qualifications in a technical field, such as agriculture, including best practices and recommendations.

The term “external information source” refers to a data provider outside the server, including another server, a database service, or a file repository, that supplies guidance data.

The term “training data set” refers to a collection of structured examples, including question sentences and corresponding answer sentences, used to adjust parameters of a machine learning model.

The term “machine learning framework” refers to a software library or runtime environment that provides functionality for defining, training, and deploying machine learning models.

The term “parameter” refers to a numerical value, such as a weight or bias in a neural network, that is adjusted during training of a model.

The term “question-and-answer record” refers to a stored data item that pairs at least one question sentence with at least one response sentence and associated metadata.

The term “expert knowledge data” refers to stored guidance data that is structured or indexed for retrieval and use in model input construction or response generation.

The term “extended input data” refers to combined input that includes a prompt sentence and one or more additional text segments, such as past records or expert data portions, provided to a generative AI model.

The term “question similarity” refers to a quantitative measure of closeness between question sentences, computed for example using vector representations or distance metrics.

The term “inference processing” refers to execution of a trained model on input data in order to produce an output, without modifying the model parameters.

The term “response candidate” refers to an intermediate or complete output text segment generated by a model as part of constructing a response sentence.

The term “response sentence” refers to natural language text generated by the system in reply to a question sentence.

The term “postprocessing” refers to operations performed on a response sentence after model inference, including formatting, unit conversion, and structuring.

The term “unit conversion” refers to transforming quantities from one measurement unit to another, such as converting temperature or length units.

The term “expression unification” refers to standardizing terminology, phrasing, and notation in a text to improve readability and consistency.

The term “structuring of important items” refers to organizing selected information into an ordered or labeled format, such as lists, sections, or key-value pairs.

The term “response information” refers to a data structure including at least the response sentence and one or more structured fields such as crop name, recommended temperature range, recommended humidity range, and soil acidity range.

The term “crop name” refers to a textual identifier for a plant species or variety that is the subject of a question or response.

The term “recommended temperature range” refers to a range of temperature values suggested by the system as suitable for a particular crop or condition.

The term “recommended humidity range” refers to a range of humidity values suggested by the system as suitable for a particular crop or condition.

The term “soil acidity range” refers to a range of soil acidity values, such as pH values, suggested by the system as suitable for a particular crop or condition.

The term “record” refers to a logical unit of stored information containing multiple related fields, such as texts, attributes, and timestamps.

The term “question text” refers to the stored natural language string that represents a question posed by a user.

The term “answer text” refers to the stored natural language string that represents a response generated by the system.

The term “crop attribute” refers to data indicating a crop-related characteristic associated with a record, such as crop type or variety.

The term “time information” refers to a value indicating a time or date at which an event, such as a question or response, was processed.

The term “aggregation processing” refers to computations that summarize multiple records, such as counting, averaging, or grouping by attribute.

The term “similarity calculation processing” refers to computations that measure similarity between data items, using for example distance metrics or similarity scores.

The term “analysis data” refers to processed information derived from stored records and computations, used to support decisions in retraining, service design, or business planning.

The term “feature vector” refers to a numerical representation of a data item, such as a question sentence, used for similarity computation or machine learning.

The term “neighborhood search processing” refers to a retrieval operation that identifies data items with feature vectors close to a query feature vector in a defined metric space.

The term “predetermined threshold” refers to a defined numeric value used as a criterion for selection or classification, such as a minimum similarity score.

The term “response generation performance” refers to a quality measure of the system's ability to produce relevant, accurate, and efficient responses.

The term “audio signal” refers to a digitized representation of sound, including speech, captured by a microphone or similar device.

The term “image signal” refers to a digitized representation of visual information, including still images or video frames, captured by an imaging device.

The term “emotional state” refers to a classification or estimation of a user's affective condition, such as calm, frustrated, or confused, determined from input signals.

The term “expression intensity” refers to the degree of emphasis or strength in wording used in a response sentence.

The term “explanation detail level” refers to a degree of granularity or completeness of information included in a response sentence.

The term “advice content” refers to prescriptive or suggestive information contained in a response sentence, including recommendations or cautions.

The term “business candidate information” refers to analysis data indicating potential service offerings, pricing structures, or additional modules that may be implemented as a business.

The term “service provision form” refers to a mode in which the system's functionality is offered, such as subscription-based access, tiered access, or on-demand access.

The term “fee structure” refers to a schedule or model of charges applied for use of the system or portions of its functionality.

The term “additional knowledge provision module” refers to a software component configured to provide supplementary information, reports, or analytics beyond baseline responses.

The term “retraining” refers to a process of further adjusting parameters of a generative AI model using additional or updated training data.

The term “learning parameter” refers to a configuration value used in the training process of a model, such as a learning rate, batch size, or number of epochs.

The term “prompt sentence including attribute information” refers to a constructed text that embeds structured data such as crop, environment, and problem type into a natural language form suitable for model input.

The term “extended input data including past question-and-answer record” refers to input for a generative AI model that combines the current prompt sentence with text derived from one or more previously stored question-and-answer records.

The term “agricultural field” refers to a technical domain related to cultivation of plants, management of soils, control of pests and diseases, and associated environmental conditions.

The server functions as a specialized information processing apparatus that hosts an agricultural question-and-answer service based on a generative AI model. The server includes at least one processor, a main memory, a non-volatile storage device, and communication circuitry connected via a hardware bus. The server operates under a general-purpose operating system executing on standard server hardware, for example, a multi-core central processing unit and, in some embodiments, one or more graphics processing units configured for numerical computation.

The server executes software components including a web application framework, an application programming interface layer, a natural language processing module, a machine learning framework implementing a generative AI model, a database management system, and an analytics engine. In one embodiment, the server executes a machine learning framework such as a tensor-based computation framework or a dynamic computation-graph framework, running on a processor that is configured with a graphics processing unit interface. The database management system may be implemented as a relational database server, and the server may also maintain an auxiliary vector index implemented by a similarity-search library.

The terminal operates as a user-side computing device, such as a smartphone, a tablet computer, or a personal computer. The terminal includes at least a display, a pointing device or touch panel, a microphone, and optionally a camera. The terminal runs a client application or a web browser which communicates with the server via a network protocol. The terminal presents a user interface screen that includes a text input area, an output display area, and optionally controls for audio or video capture.

The user operates the terminal to enter a prompt sentence in natural language related to agriculture. For example, the user may input the prompt sentence:

“What are the optimal growing conditions for tomatoes, including temperature, humidity, soil pH, and sunlight requirements?”

The user may alternatively input prompt sentences such as:

“How can I prevent powdery mildew on cucumbers in a greenhouse?” “Please give me a weekly irrigation schedule for rice in a semi-arid region.” “How should I deal with early blight on my potato plants in a humid climate?”

The terminal transmits the prompt sentence and optional metadata to the server. The metadata can include, for example, a user identifier, a region indicator, and a device type.

The server receives the prompt sentence through a network interface and stores the raw text and metadata in the storage device managed by the database management system. The server then executes a natural language preprocessing pipeline. In this pipeline, the server performs character normalization to standardize encodings and unify character variants, removes unnecessary symbols, and applies length constraint checking using programmable thresholds.

The server then executes syntactic analysis and semantic analysis by applying a natural language processing algorithm implemented in software, such as a tokenizer, a part-of-speech tagger, a dependency parser, and a named-entity recognizer.

The server uses the results of syntactic and semantic analysis to extract attribute information.

This attribute information includes, for example, a target crop (tomato, cucumber, rice, potato), a cultivation environment condition (greenhouse, semi-arid open field, high humidity climate), and a problem type (disease, pest, irrigation, nutrient deficiency). The server encodes these extracted attributes into a structured internal representation, such as records containing symbolic fields and numerical flags. The server then constructs a prompt sentence for the generative AI model by embedding the attribute information into a canonical natural language structure. This prompt sentence is different from the user's raw input and is designed to be concise and attribute-rich, which directly reduces the number of tokens processed by the generative AI model and thus lowers computational load and latency.

The server converts the constructed prompt sentence into an input format suitable for the generative AI model. The server uses a tokenizer associated with the model, for example a subword-based tokenizer, to map the prompt sentence and any additional context into a sequence of token identifiers. The server then constructs tensors representing token indices and attention masks in the memory and passes these tensors to the model execution engine in the machine learning framework.

The server previously collects guidance data containing expert knowledge about agriculture.

The server can receive expert documents through file upload, data feeds, or external databases. The server processes these documents by segmenting text into logical units, extracting topic labels (such as crop, disease, climate condition), and forming pairs of pseudo-questions and expert answers. The server generates a training dataset in which each entry includes at least a question text, an answer text, and attribute information. The server stores this training dataset in the storage device using standardized file formats and table schemas.

The server trains the generative AI model using the generated training dataset. In one embodiment, the server uses a transformer-based neural network architecture. The server configures the architecture with multiple self-attention layers, feed-forward sublayers, positional encodings, and normalization layers. The server defines model parameters in the form of weight matrices and bias vectors in each layer. The server uses a loss function such as cross-entropy loss between predicted token distributions and reference tokens. The server updates the model parameters using an optimizer algorithm, such as an adaptive gradient-based method.

The server performs the training on one or more graphics processing units to accelerate matrix multiplications and convolution-like operations. The server loads mini-batches of tokenized training examples into memory, computes forward passes to obtain probabilities over possible next tokens, computes loss values, and executes backpropagation to obtain gradients with respect to model parameters. The server updates the parameters according to the optimizer's update rule. By repeating this process over epochs, the server transforms the model from a generic language generator into a domain-adapted generative AI model specialized for agricultural question answering.

The server further refines the generative AI model using stored question-and-answer records created during system operation. The server uses the database management system and a vector index to select historical interactions that are informative and representative. The server converts stored questions and answers into feature vectors using an encoder network, and stores these vectors in an index structure that supports efficient nearest-neighbor search. The server then uses these historical examples as additional training samples or fine-tuning data. This adaptive retraining process improves the accuracy of the generative AI model and aligns its behavior with real-world usage patterns, thereby enhancing technical performance of the system as it operates over time.

At inference time, the server augments the constructed prompt sentence with additional context extracted from the storage device. The server derives a feature vector from the prompt sentence using an embedding component, such as the encoder part of a neural network or an auxiliary embedding model. The server searches the vector index to find past question-and-answer records with feature vectors similar to that of the current prompt sentence. The server uses a similarity measure, such as cosine similarity or Euclidean distance, and selects only records whose similarity exceeds a predetermined threshold. The server extracts segments of the answers and expert data portions from the selected records, and concatenates these segments with the prompt sentence to form extended input data.

This extended input data provides the generative AI model with compact, targeted context. Because the server uses feature-vector-based retrieval instead of simply increasing context size arbitrarily, the input length is controlled and redundant information is reduced. This results in improved response relevance while maintaining computation efficiency on the processor. The retrieval and concatenation operations constitute specific data processing steps implemented by the server on structured data and vector indices, and are not merely abstract concepts.

The server then executes inference processing with the generative AI model. The server passes the tokenized extended input data into the model and performs successive decoding steps using a defined strategy such as beam search or temperature-controlled sampling. The server calculates probability distributions over vocabulary tokens at each decoding step and chooses tokens according to the decoding rule. The server continues generating tokens until a stop condition is met. During this process, the model internal computations involve linear transformations, attention score calculations, activation functions, and normalization steps in each layer.

The server obtains a response sentence as a natural language string from the generated token sequence. The server performs postprocessing on this response sentence, including unit conversion (for example, Fahrenheit to Celsius, inches to millimeters), expression unification (standardized naming for crops and diseases), and structuring of important items (such as separating temperature, humidity, soil pH, and sunlight requirements into distinct labeled portions). The server creates response information that includes the response sentence and structured fields such as crop name, recommended temperature range, recommended humidity range, and soil acidity range.

The server stores both the question and the response into the database as a record, along with crop attributes, time information, and additional metadata. The server periodically executes aggregation processing and similarity calculation processing on these records. For example, the server can compute distributions of question frequencies per crop type, detect emerging problem types in certain regions, and identify topics with high user confusion. The server uses this analysis data to guide selection of data subsets for retraining, adjustment of retraining intervals, and prioritization of model updates. This closed feedback loop improves training efficiency because the server focuses computational resources on data segments that actually affect real-world performance.

The server can also process audio and image signals from the terminal, when the user provides voice input or is captured by the camera. The server extracts features from these signals using pre-trained emotion recognition networks or feature extraction algorithms. The server estimates an emotional state of the user, such as confusion or frustration, based on this feature set. The server then adjusts the level of detail, tone, and structure of the response. For example, for a novice user in a confused state, the server increases explanation detail level and includes more step-by-step instructions; for an expert user, the server may provide concise, parameter-focused guidance. This dynamic adjustment reduces unnecessary follow-up questions, thus decreasing repeated network requests and computational usage. The emotion-based adaptation is implemented as a concrete signal-processing and control mechanism executed entirely by the server.

The terminal receives the response information and presents it to the user. The terminal can highlight numerical ranges, show graphs or tables, and display warnings or cautions where necessary. The user applies the advice in real agricultural operations, such as adjusting greenhouse temperature settings, changing irrigation schedules, or selecting pest control measures.

The server contributes to technical improvement in several ways. Because the server extracts attribute information and constructs specialized prompt sentences, the amount of data processed per query by the generative AI model is reduced without sacrificing informativeness, leading to faster inference and lower resource consumption on the processor. Because the server uses retrieved context from a vector index, the generative AI model generates more accurate responses with fewer decoding steps and reduced risk of irrelevant content. Because the server uses analytics over stored records to steer retraining and because retraining is executed selectively on informative subsets, the server improves prediction accuracy while reducing overall training time and storage bandwidth. These effects are not obtained merely by replacing human judgment with a computer but by adjusting the internal data structures, processing flow, and model interaction to exploit the capabilities of the computing hardware efficiently.

The server operates with specific data structures, including normalized text records, attribute tables, vector indices, and training corpus files, and with specific algorithms, including feature extraction, similarity search, and neural network training rules. These structures and methods are designed so that the server achieves lower latency, higher throughput, and more stable behavior under varying load, therefore improving the performance of the computer system itself.

In alternative embodiments, the server may use different neural network architectures, such as an encoder-decoder transformer, a recurrent neural network with attention, or a hybrid model with convolutional layers for local feature extraction. The server may use different optimization algorithms, loss functions, or regularization methods. The retrieval mechanism may use different vector indexing structures, such as tree-based indices or compressed representations. The preprocessing and postprocessing pipelines may be adapted to support additional languages or domain-specific vocabularies. In each case, the server continues to implement the essential operations of structured attribute extraction, prompt sentence construction, context retrieval, efficient model inference, and analytic feedback for retraining, thereby realizing the same technical effects of improved computational efficiency, response accuracy, and resource utilization.

The user can thus interact with a system in which the server and the terminal cooperate to provide technically enhanced question answering for agriculture. The server performs complex internal processing that goes beyond mere automation of human tasks and instead reconfigures how data flows through the computing system, how models are trained and invoked, and how stored records are leveraged. As a result, the system provides a concrete improvement to computer technology in terms of processing speed, precision of generated outputs, and management of large-scale data and model resources.

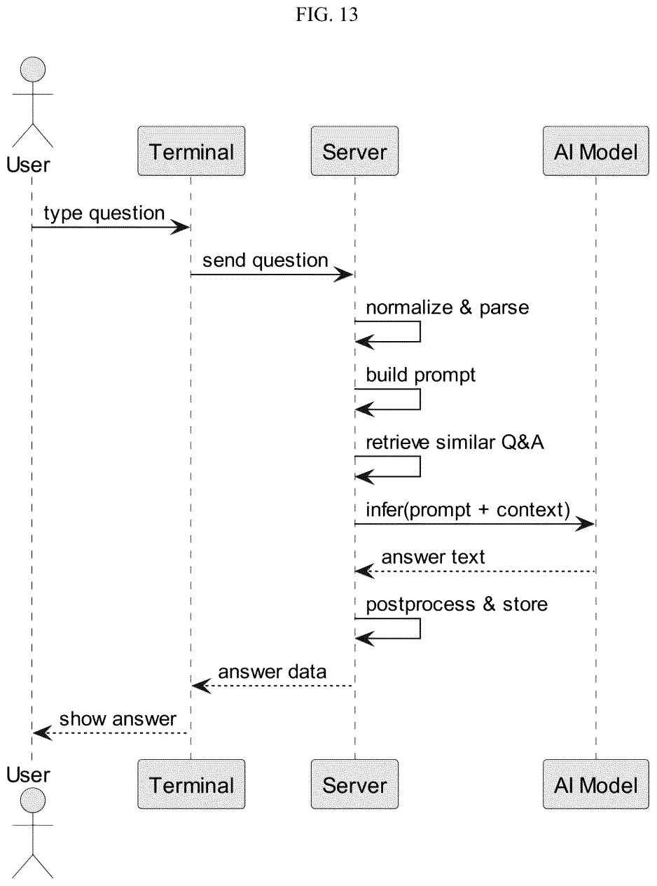

The following describes the processing flow using FIG. 13.

### Step 1:

The user operates the terminal to input a natural language question.

The user views a user interface screen on the terminal and types a prompt sentence, for example, “What are the optimal growing conditions for tomatoes, including temperature, humidity, and soil pH?” into a text input field.

Input: the user's keystrokes and any selected options on the terminal.

Output: a complete natural language prompt sentence held in the terminal's application memory.

### Step 2:

The terminal transmits the prompt sentence and metadata to the server.

The terminal constructs a request message containing the prompt sentence, a user identifier, and optional region or device information, and sends the message via a network protocol such as HTTPS to the server's endpoint.

Input: the prompt sentence and local metadata stored by the terminal.

Output: a network packet stream carrying a structured request that reaches the server's communication interface.

### Step 3:

The server receives and stores the raw request.

The server accepts the network connection, decodes the request, and extracts the prompt sentence and metadata. The server writes a new entry into a request-log table in the storage device, including the raw text, user identifier, and timestamp.

Input: the network request from the terminal containing the prompt sentence and metadata.

Output: a stored log record and an in-memory representation of the prompt sentence and associated metadata.

### Step 4:

The server performs text normalization and basic validation.

The server converts the prompt sentence to a standard character encoding, normalizes case and full-width/half-width characters, removes control characters and extraneous symbols, and checks that the length does not exceed predefined limits. If the text is empty or too long, the server generates an error response instead of proceeding.

Input: the raw prompt sentence string.

Output: a cleaned and validated prompt sentence suitable for further natural language processing, or an error indication if validation fails.

### Step 5:

The server executes syntactic and semantic analysis to extract attributes.

The server applies a natural language processing algorithm to the normalized prompt sentence, including tokenization, part-of-speech tagging, dependency parsing, and named-entity recognition. The server identifies a target crop (for example, “tomatoes”), cultivation environment conditions (for example, “greenhouse,” “semi-arid”), and a problem type (for example, “growing conditions” or “disease control”). The server encodes these into a structured attribute object with symbolic fields and, if used, numerical codes.

Input: the normalized prompt sentence.

Output: a structured attribute object containing at least target crop, cultivation environment condition, and problem type linked to the original prompt sentence.

### Step 6:

The server constructs a model-oriented prompt sentence.

The server composes a new prompt sentence that embeds the extracted attributes in a concise, canonical form, such as “Provide recommended temperature, humidity, soil pH, and sunlight conditions for cultivating tomatoes under the identified environment and problem type.” The server may insert explicit labels or separators to guide the generative AI model.

Input: the attribute object and the normalized prompt sentence.

Output: a model-oriented prompt sentence that is attribute-rich and optimized for tokenization and model input.

### Step 7:

The server tokenizes the model-oriented prompt sentence.

The server invokes a tokenizer associated with the generative AI model to convert the prompt sentence into a sequence of token identifiers. The server then constructs tensor structures (for example, integer arrays and attention masks) in the server's memory to represent the token sequence in the model's expected format.

Input: the model-oriented prompt sentence as a text string.

Output: token IDs and attention mask tensors ready for input to the generative AI model.

### Step 8:

The server retrieves similar past question-and-answer records.

The server generates a feature vector from the prompt sentence using a text-embedding component. The server queries a vector index that stores feature vectors for past questions and identifies nearest neighbors whose similarity to the current vector is above a predetermined threshold. The server retrieves corresponding question-and-answer records from the database.

Input: the feature vector representing the current prompt sentence and the vector index of stored records.

Output: a set of past question-and-answer records and expert snippets relevant to the current prompt sentence.

### Step 9:

The server forms extended input data by combining current and retrieved information.

The server selects portions of the retrieved answers and expert snippets, filters out redundant or low-relevance content, and concatenates the selected text with the model-oriented prompt sentence in a structured layout. The server then re-tokenizes this combined text and generates new token and mask tensors for the generative AI model.

Input: the model-oriented prompt sentence and the retrieved question-and-answer and expert text segments.

Output: extended input text and corresponding token and mask tensors providing compact but enriched context for the generative AI model.

### Step 10:

The server runs inference on the generative AI model.

The server supplies the extended input tensors to the generative AI model executing within the machine learning framework. The server computes forward passes through the model's layers, calculating attention weights, intermediate activations, and token probability distributions. The server then performs decoding using a configured algorithm, such as beam search or temperature-based sampling, to choose output tokens step-by-step until a stop condition is met.

Input: token and mask tensors representing the extended input data.

Output: a sequence of output token IDs representing a generated response in tokenized form.

### Step 11:

The server converts output tokens into a natural language response sentence.

The server uses the tokenizer's decode function to map the output token IDs back into a text string. The server trims incomplete trailing fragments, resolves special tokens, and ensures that the response sentence forms coherent natural language.

Input: the sequence of output token IDs from the generative AI model.

Output: a raw response sentence as a text string.

### Step 12:

The server postprocesses and structures the response information.

The server scans the response sentence to detect numerical values and associated units, converting them into standardized units where necessary. The server enforces consistent terminology for crop names and conditions, and extracts key parameters such as recommended temperature range, recommended humidity range, and soil acidity range. The server constructs a response information object that includes the full response sentence and the extracted parameters in structured fields.

Input: the raw response sentence string.

Output: a structured response information object containing both narrative text and labeled technical parameters.

### Step 13:

The server stores the interaction as a record.

The server creates a record combining the original prompt sentence, the attribute object, the response sentence, the structured parameters, and metadata such as user identifier and timestamp. The server writes this record to the database and, optionally, generates and stores a feature vector for the question for future similarity searches.

Input: the prompt sentence, extracted attributes, response information, and metadata.

Output: a persistent question-and-answer record and, in some embodiments, an updated vector index entry.

### Step 14:

The server analyzes stored records for system optimization.

The server periodically reads sets of records from the database and calculates metrics such as question frequency per crop, distribution of problem types, and regional trends. The server uses similarity calculation processing to detect clusters of related questions and identifies segments of data that are under-represented or over-represented. These computations generate analysis data that the server stores in separate analytics tables.

Input: collections of stored question-and-answer records.

Output: aggregated statistics, similarity clusters, and analysis data used for retraining selection and system tuning.

### Step 15:

The server adjusts training data selection and model configuration.

The server uses the analysis data to choose which subsets of stored records to include in retraining or fine-tuning of the generative AI model, prioritizing records from high-impact categories or under-served crop types. The server configures updated training datasets, modifies learning parameters such as learning rate or batch size, and schedules retraining tasks.

Input: analysis data and stored question-and-answer records.

Output: a curated training dataset and updated training configuration parameters for future model training runs.

### Step 16:

The server transmits the response information to the terminal.

The server formats the response information object into a network response message, including the narrative response sentence and any structured fields, and sends this message via the communication circuitry back to the terminal using the established network protocol.

Input: the structured response information object.

Output: a response message delivered over the network to the terminal.

### Step 17:

The terminal displays the response to the user.

The terminal parses the received response message, extracts the response sentence and parameters, and updates the user interface. The terminal renders the narrative answer in a text area and may display the recommended temperature range, humidity range, and soil acidity range as highlighted values or in separate labeled fields.

Input: the response message from the server.

Output: a visual presentation of the response on the terminal's display that the user can read and act upon.

### Step 18:

The user interprets the response and optionally issues follow-up questions.

The user reviews the displayed response, compares the recommended conditions to actual conditions in the agricultural environment, and may adjust real-world settings accordingly. If further clarification is needed, the user inputs another prompt sentence on the terminal, which becomes new input and restarts the processing flow from the earlier steps.

Input: the displayed response information perceived by the user.

Output: informed user actions in the real environment and, when necessary, a new prompt sentence for additional processing.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional question-answering systems that incorporate machine learning or generative artificial intelligence models typically treat a user's natural-language input as a static text string and directly submit that text to a backend model. Such systems generally lack a mechanism to (i) perform structured, model-aware preprocessing of the input, (ii) construct a rich, context-sensitive prompt sentence tailored to the specific generative AI model, and (iii) systematically adjust that prompt sentence and the model's output based on user state information, such as emotion or interaction history. As a result, these systems often generate responses that are sub-optimal in accuracy, coherence, user suitability, or consistency across sessions. In addition, in many existing architectures, user interaction logs, including past questions, answers, and inferred emotional states, are not effectively reused to refine the behavior of the natural-language processing pipeline or the generative AI model, which limits the ability of the system to improve over time as a computing platform.

Furthermore, typical systems do not integrate domain-specific knowledge retrieval and user history retrieval into the prompt construction process in a unified and programmable manner at the processor level. Domain knowledge, if used at all, is often injected through ad-hoc templates or manual curation outside the core computational flow, leading to brittle behavior and significant maintenance overhead. User emotion, when recognized, is frequently handled only at the user interface layer and does not reliably constrain or guide token-level generation inside the generative AI model. Consequently, these architectures fail to exploit available computational resources and data structures to systematically control the internal generative process, which results in increased computational waste (for example, repeated generation of irrelevant candidate responses) and degraded responsiveness and reliability of the overall information processing apparatus.

Moreover, existing systems often lack a structured mechanism by which a processor can analyze accumulated interaction history using statistical analysis or machine learning to derive domain-level demand trends or service-improvement indicators, and then programmatically feed those indicators back into the generation rules for prompt sentences, the training data for generative AI models, or higher-level business planning logic. Without such a feedback mechanism at the system architecture level, the computing system remains largely static, cannot efficiently adapt to changing user behavior patterns, and cannot exploit long-term data to improve model performance or service quality. Accordingly, there is a need for an improved information processing system and server that integrates prompt-centric control of a generative AI model, emotion-adaptive response generation, and interaction-history-driven model updating, in order to enhance the technical performance of the underlying computing platform, including robustness, efficiency, adaptability, and quality of generated responses.

The specific processing by the specific processing unit 290 of the data processing device 12 in Application Example 2 is realized by the following means.

The present invention provides a server comprising a processor configured to acquire inquiry information from a user via an input apparatus; perform preprocessing on the acquired inquiry information by using language processing technology to identify an intention and a domain of the inquiry information; dynamically generate, based on a result of the identification and on user state information, a prompt sentence for input to a generative AI model; acquire, from a storage apparatus, domain-specific knowledge information corresponding to a target included in the inquiry information and user history information; integrate the domain-specific knowledge information and the user history information into the prompt sentence as context information; supply input information including the prompt sentence to the generative AI model; cause the generative AI model to generate response candidate information by inference processing; determine final response information by performing token sequence selection processing or output control processing based on a probability distribution on the response candidate information; present the final response information to the user via an output apparatus; store, in the storage apparatus, the inquiry information, the prompt sentence, the final response information, and the user state information in association with one another; perform emotion estimation processing on user state information including audio information and image information to identify a user emotion; modify, according to the identified user emotion, at least one of tone instruction information and explanation-detail instruction information in the prompt sentence and expression content of the final response information to generate emotion-adaptive response information; record the inquiry information, the final response information, and user emotion information as inquiry history information in a data storage apparatus; perform statistical analysis processing or machine learning processing on the inquiry history information to extract domain-specific demand-trend information or service-improvement candidate information; and update at least one of generation rules for the prompt sentence, learning data for the generative AI model, and business planning information by using the extracted information. This enables the computing system to tightly couple natural-language preprocessing, prompt-centric control of a generative AI model, emotion-aware response adaptation, and data-driven model updating, thereby improving the technical performance of the server as an information processing apparatus in terms of response relevance, stability, adaptability, and computational efficiency.

The term “inquiry information” refers to information representing a request, question, or command input by a user to the system in a natural-language or structured form. The term “input apparatus” refers to a hardware or software component that receives data from a user, such as a keyboard, pointing device, touch panel, microphone, camera, or network-based user interface.

The term “output apparatus” refers to a hardware or software component that presents data to a user, such as a display device, speaker, headset, or graphical user interface.

The term “language processing technology” refers to a set of algorithms or software modules that analyze, transform, or interpret natural-language data, including at least one of tokenization, morphological analysis, syntactic parsing, semantic analysis, intent classification, and named-entity recognition.

The term “intention” refers to a semantic objective or purpose of a user's inquiry, such as a request for information, an instruction to perform an operation, or a request for a recommendation.

The term “domain” refers to a category or field of knowledge or application, such as a particular technical area, product category, service type, or topic classification, associated with the inquiry information.

The term “prompt sentence” refers to text or a sequence of tokens provided as input to a generative AI model, the text or sequence including instructions, context, or example content that guides the behavior and output of the generative AI model.

The term “generative AI model” refers to a trained computational model that generates output data, such as natural-language text, based on input data, using machine learning techniques including at least one of deep neural networks and probabilistic sequence models.

The term “user state information” refers to data describing a current or recent condition of a user, including at least one of audio information, image information, behavioral information, physiological information, and inferred emotional information.

The term “domain-specific knowledge information” refers to structured or unstructured information related to a particular domain, such as reference data, rules, parameters, or facts, that can be used to supplement or constrain responses generated by the system.

The term “user history information” refers to information describing past interactions or behavior of a user, including at least one of previous inquiries, previous responses, feedback data, access logs, and preference indicators.

The term “context information” refers to data associated with an inquiry or prompt that provides additional background, constraints, or examples to influence processing or generation by the system, including at least one of domain-specific knowledge information and user history information.

The term “inference processing” refers to computation performed by a trained model to produce output data from input data, including the forward propagation of activations through a neural network without updating model parameters.

The term “response candidate information” refers to one or more intermediate response outputs generated by a generative AI model prior to selection or refinement into final response information.

The term “token sequence selection processing” refers to processing that selects a sequence of tokens from one or more candidate sequences by applying criteria such as likelihood scores, decoding strategies, or heuristic rules.

The term “output control processing based on a probability distribution” refers to processing that controls or adjusts generated output by using probability values associated with tokens or token sequences, including at least one of greedy decoding, sampling, beam search, and probability thresholding.

The term “final response information” refers to response data, typically natural-language text or structured content, selected or generated by the system as an output to be provided to the user.

The term “emotion estimation processing” refers to processing that infers or classifies a user's emotional state from data, including at least one of audio feature analysis and facial feature analysis.

The term “audio information” refers to data representing sound captured from a user, including at least one of raw audio waveforms, compressed audio streams, and derived acoustic features.

The term “image information” refers to data representing visual content captured from or about a user, including at least one of still images, video frames, and derived visual features.

The term “audio feature analysis processing” refers to processing that extracts numerical or symbolic features from audio information, such as pitch, energy, spectral characteristics, or prosodic patterns, for use in emotion estimation or other analysis.

The term “facial feature analysis processing” refers to processing that detects and analyzes characteristics of a user's face in image information, such as facial landmarks, expressions, or movements, for use in emotion estimation or other analysis.

The term “user emotion” refers to an inferred emotional state of a user, such as happiness, sadness, anger, confusion, or neutrality, represented as at least one of a discrete label, a continuous value, or a probability distribution.

The term “tone instruction information” refers to data included in or associated with a prompt sentence that specifies a desired style or manner of expression for a generated response, such as politeness level, formality, empathy, or directness.

The term “explanation-detail instruction information” refers to data included in or associated with a prompt sentence that specifies a desired degree of granularity or detail for a generated explanation, such as whether the explanation should be high-level, step-by-step, or expert-level.

The term “emotion-adaptive response information” refers to response data whose content and/or style has been adjusted based on estimated user emotion, including modifications to wording, level of detail, or additional supportive expressions.

The term “inquiry history information” refers to stored data that associates at least inquiry information, final response information, and user emotion information for one or more past interactions.

The term “data storage apparatus” refers to any hardware and software combination configured to store and retrieve digital data, including at least one of a magnetic storage device, a semiconductor storage device, an optical storage device, and a network-accessible storage system.

The term “statistical analysis processing” refers to processing that computes statistics, patterns, or correlations from data, including at least one of frequency analysis, trend analysis, clustering, and regression analysis.

The term “machine learning processing” refers to processing that trains, updates, or applies a computational model to data in order to perform prediction, classification, clustering, or other inference tasks.

The term “domain-specific demand-trend information” refers to information describing patterns or trends in user inquiries, interests, or behavior within a particular domain, derived from analysis of inquiry history information.

The term “service-improvement candidate information” refers to information indicating potential modifications, optimizations, or enhancements to system behavior, content, or configuration, derived from analysis of inquiry history information.

The term “generation rules for the prompt sentence” refers to rules or parameters that determine how a prompt sentence is constructed from inquiry information, context information, and user state information, including templates, selection conditions, and weighting schemes.

The term “learning data for the generative AI model” refers to training or fine-tuning data used to adjust parameters of a generative AI model, including at least question-answer pairs, interaction logs, and annotated examples.

The term “business planning information” refers to information used to design, manage, or adjust service offerings, policies, or operational strategies of a system provider, including at least one of service configuration data, usage targets, and content prioritization data.

In one embodiment, a server cooperates with one or more terminals and users to implement a context-adaptive response generation system based on a generative AI model and a dynamically constructed prompt sentence. The system is implemented on general-purpose computer hardware, such as a server including a central processing unit (CPU), a graphics processing unit (GPU), a main memory, a non-volatile storage device, and a network interface. The server executes an operating system, for example a UNIX-like operating system, and runs application software modules including a natural-language processing module, an emotion estimation module, a prompt-generation module, a generative AI inference module, and a data-analysis module. The terminal operates as a user interface device and includes at least one processor, a memory, an input apparatus such as a microphone, camera, touch panel, or keyboard, and an output apparatus such as a display and a speaker.

In one embodiment, the server uses a deep neural-network-based language model, implemented for example by a Transformer architecture provided via a machine learning framework such as a generic deep learning framework. The generative AI model includes an embedding layer that converts discrete token identifiers into dense numeric vectors, a plurality of self-attention layers that compute contextualized representations, and a decoding layer that computes probability distributions over vocabulary tokens. The server represents each tokenized prompt sentence and each partial output as sequences of integer token identifiers, and the server stores such sequences in contiguous arrays in memory to enable efficient batched matrix operations on the GPU.

The server uses a language processing module implemented for example with a general-purpose natural-language toolkit. The server applies tokenization rules, part-of-speech tagging, and named-entity recognition to inquiry information. The server generates intermediate data structures such as an “intention record” (containing an intention label, confidence values, and a list of key tokens) and a “domain record” (containing a domain label and associated metadata). The server stores these records in an in-memory key-value store associated with the current interaction. Because the server maintains these structured records, the server can construct prompt sentences that explicitly encode intention, domain, and context without re-parsing the raw text, thereby reducing redundant computation and latency.

In one embodiment, the server uses an emotion estimation module that processes audio information and image information supplied by the terminal. The server applies an audio feature extraction pipeline, in which the server computes Mel-frequency cepstral coefficients (MFCCs), pitch contours, and energy statistics from digital audio frames. The server applies a visual feature extraction pipeline, in which the server detects a face region in an image using a convolutional neural network and then computes an embedding vector representing facial expression features. The server concatenates or otherwise fuses these feature vectors into a fixed-length emotion feature vector and inputs this vector into a trained classifier, such as a neural network having multiple fully connected layers and a softmax output layer. The server outputs a discrete user emotion label, such as “confused”, “angry”, or “calm”, together with a probability distribution across emotion classes. The server stores these results as user state information in a structured record associated with the interaction.

The server uses a storage apparatus, such as a relational database system or a key-value store, to store domain-specific knowledge information and user history information. The server represents domain-specific knowledge, for example agricultural product information or general technical information, as structured tables including fields such as identifier, category, recommended usage parameters, and textual descriptions. The server represents user history information as records including at least an interaction identifier, timestamps, inquiry information, prompt sentences used, final response information, emotion labels, and user feedback. The server indexes these records using appropriate keys so that the server can efficiently retrieve relevant information during subsequent interactions.

The server constructs a prompt sentence by combining multiple layers of information into a single or multi-segment text instruction. In one embodiment, the server composes the prompt sentence as a concatenation of: (i) a system-level instruction describing the role and style of the generative AI model, (ii) a domain-specific context section containing summarized domain-specific knowledge information and relevant user history information, (iii) an emotion-related instruction indicating the user emotion and required tone or level of detail, and (iv) the original user inquiry information. The server may, for example, generate a prompt sentence of the following form:

“You are an expert assistant in a specific domain. The user has the following background and interaction history: [context summary]. The user currently appears confused and frustrated.

Provide a clear, step-by-step explanation using simple language. User inquiry: ‘Please explain how to grow tomatoes. I am having a lot of trouble and feel frustrated.’”

In another example, when the server handles a product-specific question, the server may generate a prompt sentence such as:

“You are an expert assistant in a retail environment. Based on the following product information and usage recommendations: [product context], answer the user's question in simple terms. User inquiry: ‘Which crops is this fertilizer best suited for?’”

The server encodes the prompt sentence into tokens, passes the tokens to the generative AI model, and obtains response candidate information as sequences of tokens. The server executes decoding algorithms such as beam search or sampling with constraints on maximum sequence length and token probabilities. The server uses token sequence selection processing to exclude sequences whose cumulative log-probability falls below a predetermined threshold or that violate specific constraints such as presence of prohibited terms. By operating in this manner, the server reduces the probability of generating irrelevant or low-quality responses and reduces wasted computation associated with exploring unlikely sequences.

The server uses emotion-adaptive rules to modify the prompt sentence and/or the generated response. For example, when the server identifies a “confused” user, the server inserts into the prompt sentence explicit instructions such as “break the answer into numbered steps, avoid specialist jargon, and include a confirmation question at the end.” When the server identifies an “angry” user, the server specifies that the response should include an apology and concise corrective instructions. By encoding emotion-specific constraints within the prompt sentence, the server steers the generative AI model toward token sequences that satisfy these constraints, and the server can enforce additional checks on the output to ensure that the final response information conforms to the requested tone and level of detail. This multi-stage control mechanism improves the predictability and stability of generation compared to simply post-editing arbitrary model output.

The server further uses the interaction history as learning data to update internal models. The server periodically retrieves stored inquiry history information, including inquiry information, prompt sentences, final response information, and user emotion information.

The server applies statistical analysis processing to compute, for example, frequencies of specific intention-domain combinations, distribution of user emotions over time, and correlation between certain prompt patterns and positive user feedback. The server also applies machine learning processing to retrain or fine-tune models, such as training a new intent classifier on updated labels, or fine-tuning the generative AI model on pairs of inquiry information and final response information filtered for high user satisfaction. The server uses a loss function such as cross-entropy between predicted and target token sequences and performs weight updates using an optimization algorithm such as stochastic gradient descent or an adaptive gradient method. Because the server systematically incorporates real interaction data into model updates, the server can improve prediction accuracy and reduce error rates over time.

The server thus does more than merely automate human response writing. The server internally decomposes the problem into machine-interpretable sub-tasks: intention identification, domain determination, emotion estimation, context retrieval, prompt sentence construction, constrained sequence generation, and feedback-driven updating. Each sub-task is implemented using specific data structures (for example, intention records, domain records, emotion feature vectors, context summaries, and token sequences) and algorithms (for example, Transformer attention calculations, beam search, and supervised learning). This architecture yields technical effects such as reduced processing latency, because the server reuses intermediate structured representations instead of reanalyzing raw text; improved response accuracy, because prompt sentences explicitly encode domain and context; and improved computational efficiency, because the server prunes low-probability sequences early and reduces unnecessary inference cycles.

In one embodiment, the terminal is implemented as a mobile communication device. The terminal acquires digital audio from a microphone and digital images from a camera. The terminal executes a local preprocessing module that compresses audio and image data and may compute lightweight features such as average volume or simple facial bounding boxes.

The terminal transmits these data to the server over a wireless communication network. By performing partial preprocessing on the terminal, the system reduces network bandwidth usage and avoids transmitting raw high-volume data, thereby decreasing communication load and improving responsiveness in network-constrained environments.

In another embodiment, the terminal is implemented as an augmented-reality display device. The terminal overlays text representing the final response information onto a field of view captured by a camera. The server generates not only natural-language response text but also layout metadata, such as relative priority of information segments or recommended highlight positions. The terminal uses this metadata to adjust font size, color, and placement of text on the display. In this embodiment, the system directly controls the configuration and operation of a physical display apparatus based on the generated content and thus provides a technical effect in a human-machine interface that would not be achieved by a simple generic question-answering engine.

In a further embodiment, the server maintains separate parameter sets or decoding strategies for different domains. The server selects a decoding profile based on the domain label, such that some domains use lower temperature and shorter maximum lengths (for concise operational instructions) while others use higher temperature and more diverse outputs (for exploratory recommendations). The server stores these profiles in a configuration database and applies them programmatically at run-time. This separation allows the server to tune computational resources and output characteristics per domain, improving both answer quality and resource utilization.

In another variant, the server incorporates rule-based constraints into token sequence selection processing. The server maintains a dictionary of domain-specific forbidden phrases, mandatory inclusion patterns, or structural templates. During decoding, the server evaluates candidate sequences against these rule sets and discards candidates that violate hard constraints, such as exceeding a maximum allowed dosage value in an instruction context.

This hybrid of neural sequence generation and symbolic rule enforcement constitutes a non-conventional combination that reduces risk of unsafe or inconsistent outputs and improves reliability beyond what a generic generative AI model could provide.

In some embodiments, the server logs internal metrics such as inference time per interaction, number of tokens generated, and proportion of responses requiring regeneration. The server uses these metrics in combination with inquiry history information to adjust system parameters. For example, the server may reduce maximum token length or adjust beam width for specific domains that consistently exhibit long generation times without corresponding benefit to user satisfaction. This continuous optimization loop directly improves the technical characteristics of the server as a computing system, such as throughput and average latency.

In another embodiment, the server uses data augmentation techniques when retraining internal models. The server applies paraphrasing transformations to inquiry information, shuffles non-critical segments within prompt sentences, and synthesizes additional examples from templates. The server uses these augmented datasets to train intent classifiers and emotion estimators that are more robust to linguistic variation and noise, thereby reducing misclassification rates and improving downstream prompt-generation quality.

In yet another embodiment, the server separates the generative AI inference module into a microservice that runs on specialized GPU hardware, and the prompt-generation and post-processing modules run on CPU-oriented microservices. The server communicates between these microservices using a lightweight binary protocol and batches multiple prompt sentences into a single inference request when possible. This architecture improves hardware utilization efficiency and reduces overhead due to repeated model loading, thereby achieving improved processing speed and scalability compared to a monolithic implementation.

In all of these embodiments, the server utilizes specific hardware and software structures, detailed data representations, and defined algorithmic flows to implement the claimed functions of acquiring inquiry information, generating and applying a prompt sentence for a generative AI model, integrating domain-specific knowledge and user history, estimating user emotion, generating emotion-adaptive response information, and updating model behavior based on interaction history. The system therefore improves the operation of the computer itself by increasing the effectiveness and efficiency with which the computing resources generate high-quality, context-appropriate responses, and by enabling adaptive optimization that cannot be practically performed solely by human operators.

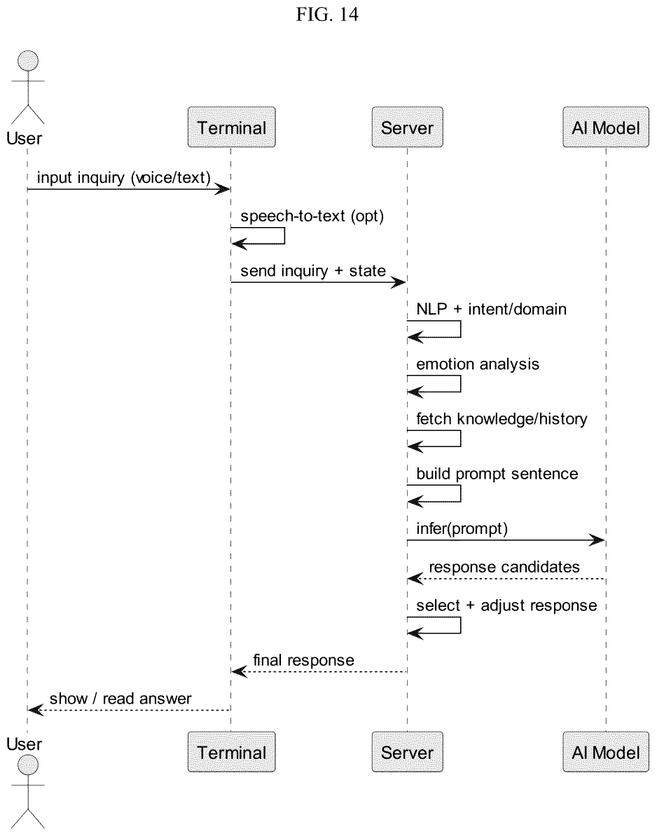

The following describes the processing flow using FIG. 14.

### Step 1:

User operates the terminal and provides inquiry information.

User speaks into a microphone or types text into an input field on the terminal. The input is raw user data in the form of an audio waveform (for voice input) or a character string (for text input). The output of this step is captured audio data or raw text data stored in a buffer in the terminal's memory.

### Step 2:

Terminal converts voice input into text data.

Terminal takes the captured audio waveform as input and calls a speech recognition library or a remote speech recognition service. Terminal segments the audio into frames, encodes the frames, and sends them to the recognition engine, which applies acoustic and language models to output a transcription string. The input is digital audio data, and the output is a text string representing the user's inquiry. Terminal normalizes the text (for example, trims whitespace and standardizes character encoding) and stores the normalized text for further processing.

### Step 3:

Terminal acquires optional user state information.

Terminal captures additional data such as an image from a camera and a short audio segment around the inquiry. The input is sensor data (image frames and audio frames). Terminal computes lightweight features, for example average volume, speaking rate, or a face bounding box, or forwards the raw data to an external emotion service. The output is user state information such as preliminary emotion scores or features, which terminal stores and attaches to the inquiry.

### Step 4:

Terminal transmits the inquiry information and user state information to the server.

Terminal takes the normalized text inquiry and user state information as input and constructs a structured request message, for example a JSON object. Terminal includes fields such as inquiry text, device identifier, timestamps, and emotion features. Terminal sends this message through a communication interface to the server using a network protocol. The output is a network request delivered to the server's endpoint.

### Step 5:

Server receives the request and validates input data.

Server accepts the network request as input, parses the message body, and extracts fields such as inquiry text and user state information. Server performs validation checks, for example confirming that required fields are present and that text length is within allowable limits. The output is a validated interaction object in server memory, which aggregates inquiry text, user features, and metadata under a unique interaction identifier.

### Step 6:

Server performs natural-language preprocessing on the inquiry information.

Server takes the inquiry text from the interaction object as input and applies a language processing module. Server tokenizes the text into tokens, identifies part-of-speech tags, and detects named entities (for example, crop names, product types, or temporal expressions).

Server may perform lemmatization and stop-word removal to obtain a set of core content tokens. The output is a set of structured linguistic features, including a token sequence, entity list, and syntactic annotations stored in an intention record associated with the interaction.

### Step 7:

Server determines the intention and domain of the inquiry.

Server uses the linguistic features as input to an intention and domain classifier. Server computes feature vectors from token embeddings, entity indicators, and positional features, and applies a classification algorithm, such as a neural network or a support vector machine, to infer an intention label and a domain label. The input is the structured linguistic feature set, and the output is an intention record and a domain record that include labels, confidence scores, and key tokens. Server stores these records in the interaction context.

### Step 8:

Server refines user state information and estimates user emotion.

Server takes user state information (for example audio features and image features) as input and applies an emotion estimation module. Server calculates additional audio descriptors such as pitch contour and spectral energy, and constructs image feature vectors from detected facial regions. Server concatenates these features and feeds them into an emotion classifier that outputs a probability distribution over emotion categories. The input is processed sensor features, and the output is a user emotion label and emotion probability values stored as user emotion information in the interaction context.

### Step 9:

Server retrieves domain-specific knowledge information relevant to the inquiry.

Server uses the domain record and entity list as input to query a knowledge database. Server executes search operations, for example SQL queries or index lookups, to retrieve entries such as product descriptions, recommended usage conditions, or technical parameters. Server may aggregate or filter retrieved records based on matching scores or recency. The input is the identified domain and entities, and the output is a domain-specific knowledge set represented as structured data and short textual summaries.

### Step 10:

Server retrieves user history information relevant to the current interaction.

Server takes the user identifier and intention/domain labels as input and queries a history storage apparatus. Server retrieves previous interactions with similar intentions or domains, including past inquiries, past responses, and emotion patterns. Server applies ranking or clustering to select the most relevant history items. The input is user identifier and classification results, and the output is a user history summary that captures user preferences, past confusion points, or feedback.

### Step 11:

Server generates a context summary for prompt construction.

Server uses the domain-specific knowledge set and user history summary as input and performs text summarization or template filling. Server extracts key fields such as recommended parameters, common issues, and prior feedback, and concatenates them into a condensed context paragraph. The input is structured knowledge and history data, and the output is a context summary text that will be embedded into the prompt sentence.

### Step 12:

Server constructs a prompt sentence for the generative AI model.

Server takes as input the intention record, domain record, user emotion information, the context summary, and the original inquiry text. Server applies a prompt-generation algorithm that selects an appropriate prompt template based on the domain and intention and inserts variables with the collected information. Server sets tone instruction information and explanation-detail instruction information according to the user emotion. The output is a complete prompt sentence (or a set of prompt segments) that instructs the generative AI model. For example, server may output:

“You are an expert assistant in a specific domain. The user has the following background and interaction history: [context summary]. The user currently appears confused and frustrated. Provide a clear, step-by-step explanation using simple language. User inquiry: ‘Please explain how to grow tomatoes. I am having a lot of trouble and feel frustrated.’”

### Step 13:

Server encodes the prompt sentence into model-specific tokens.

Server uses the prompt sentence as input and applies a tokenizer associated with the generative AI model. Server converts the text into a sequence of token identifiers, computes token type identifiers and positional indices, and stores these as arrays in memory. The input is the text prompt, and the output is a tokenized representation suitable for GPU-based inference.

### Step 14:

Server executes inference of the generative AI model.

Server supplies the tokenized prompt representation as input to the generative AI model deployed on a processor or accelerator. Server performs matrix multiplications and attention computations layer by layer according to the model architecture to obtain hidden representations and output logits for each potential next token. Server then applies a decoding strategy such as greedy decoding, sampling, or beam search. The input is the tokenized prompt sentence, and the output is one or more token sequences representing response candidate information.

### Step 15:

Server performs token sequence selection and output control.

Server takes the response candidate information as input and calculates cumulative log-probabilities and other quality metrics such as length, repetition rate, or compliance with constraints. Server checks each candidate sequence against rule sets, including forbidden phrases, required structures, and domain-specific bounds. Server discards candidates that violate constraints and selects the candidate with the best combined score. The input is the set of generated token sequences and associated scores, and the output is a single selected token sequence that represents preliminary final response information.

### Step 16:

Server decodes the selected token sequence into text.

Server takes the selected token sequence as input and applies the model's vocabulary mapping to convert token identifiers into text fragments. Server concatenates tokens, handles spacing and punctuation rules, and normalizes the resulting string. The input is a token identifier sequence, and the output is a natural-language response string.

### Step 17:

Server adjusts the response according to user emotion and system policies.

Server uses the response string and the user emotion information as input and applies emotion-adaptive rules. Server may prepend an apology phrase for an angry user, insert step numbers and clarifying examples for a confused user, or append supportive remarks for a sad user. Server also applies formatting rules, for example breaking the text into paragraphs or bullet points. The input is the raw response text and emotion label, and the output is adjusted final response information ready for presentation.

### Step 18:

Server packages the final response information and logs interaction data.

Server takes the adjusted final response information, the original inquiry information, the prompt sentence, and user emotion information as input. Server constructs a response message containing the final response text and optional structured fields such as steps and highlights. Server also writes a log entry to the storage apparatus that associates the inquiry, prompt, final response, and emotion in an inquiry history record. The input is interaction context data, and the output is a response packet for the terminal and a persisted history record for future analysis.

### Step 19:

Server transmits the final response information to the terminal.

Server uses the response packet as input and sends it over the communication interface to the terminal. Server encodes the packet according to a communication protocol and ensures delivery. The input is the structured response, and the output is a network transmission that reaches the terminal.

### Step 20:

Terminal receives and parses the final response information.

Terminal takes the network response as input, decodes the message format, and extracts fields such as final response text, steps, and any metadata. Terminal stores the parsed response in memory for display and optionally for local logging. The input is the response packet, and the output is parsed response data available to the user interface components.

### Step 21:

Terminal presents the final response information to the user.

Terminal uses the parsed response data as input and updates user interface elements, such as text areas, list views, or overlays, to display the response. Terminal may also call a text-to-speech engine to synthesize audio and play it through a speaker. The input is final response information, and the output is visual and/or auditory signals perceivable by the user.

### Step 22:

User reviews the response and optionally provides feedback.

User reads or listens to the response information. User may provide explicit feedback, such as pressing “helpful” or “not helpful” buttons, or may ask a follow-up question. The input is the presented response, and the output is user feedback data or new inquiry information to be processed in a subsequent cycle.

### Step 23:

Server analyzes accumulated inquiry history information for model and rule updates.

Server periodically takes inquiry history records, including inquiries, prompt sentences, final responses, emotions, and feedback, as input. Server performs statistical analysis, such as counting intention-domain pairs, measuring average response length, and correlating prompt patterns with positive feedback. Server may also prepare training datasets for retraining or fine-tuning the generative AI model or auxiliary models. The input is stored history data, and the output is updated model parameters, updated prompt generation rules, or configuration changes that improve future processing accuracy and efficiency.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

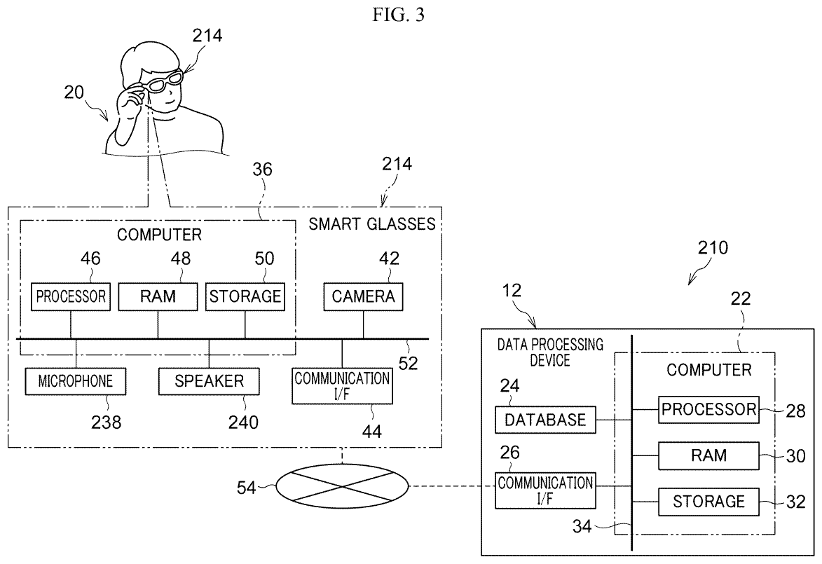

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

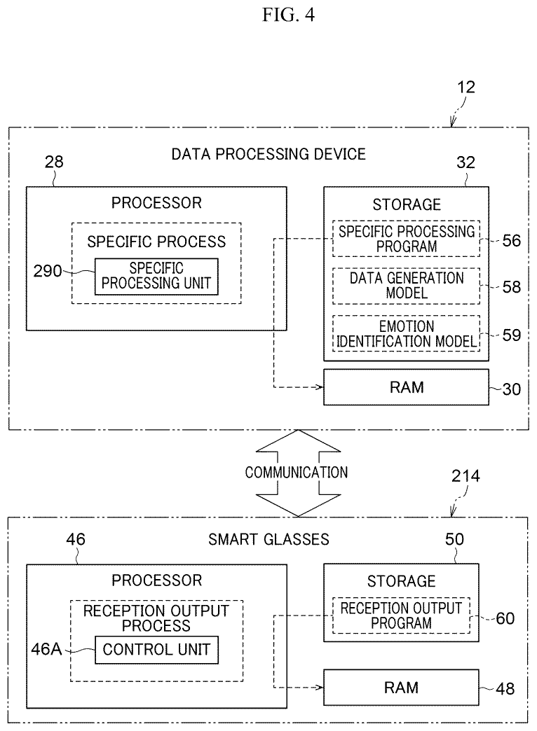

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

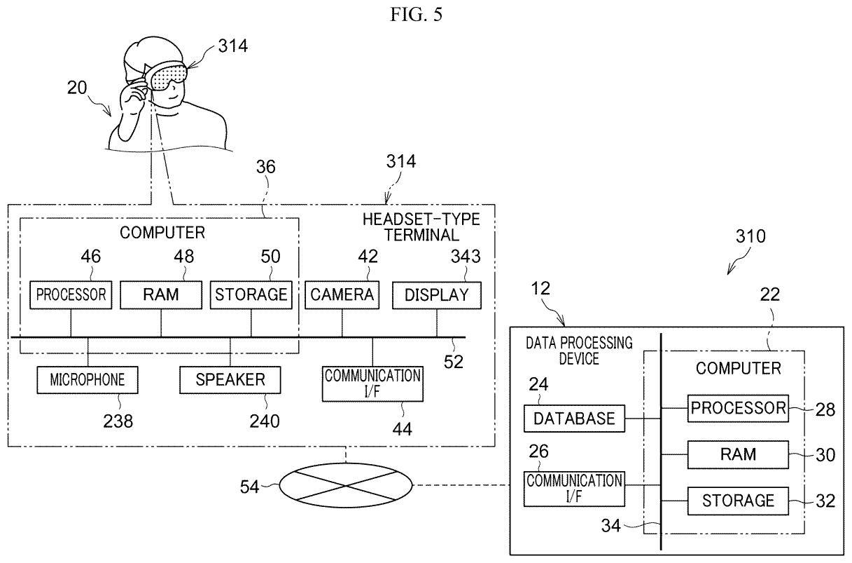

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

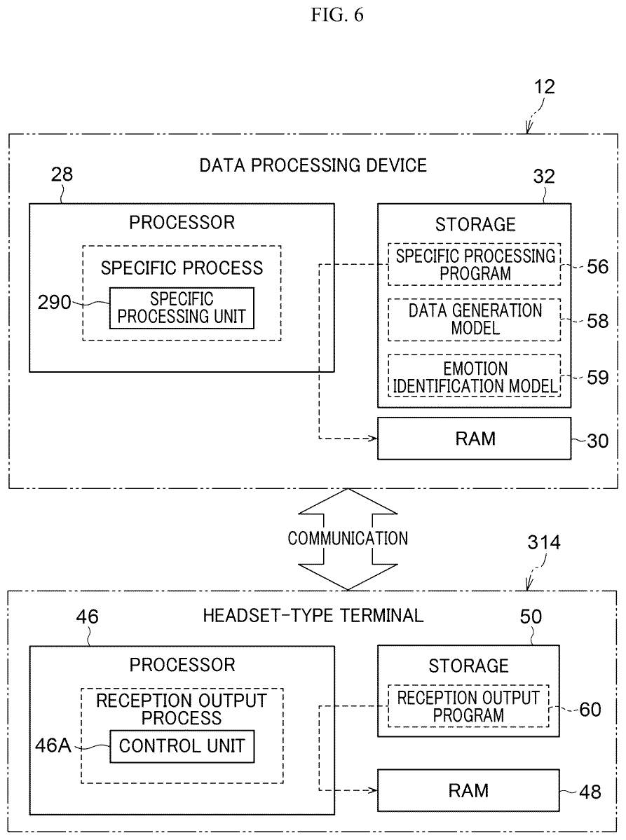

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

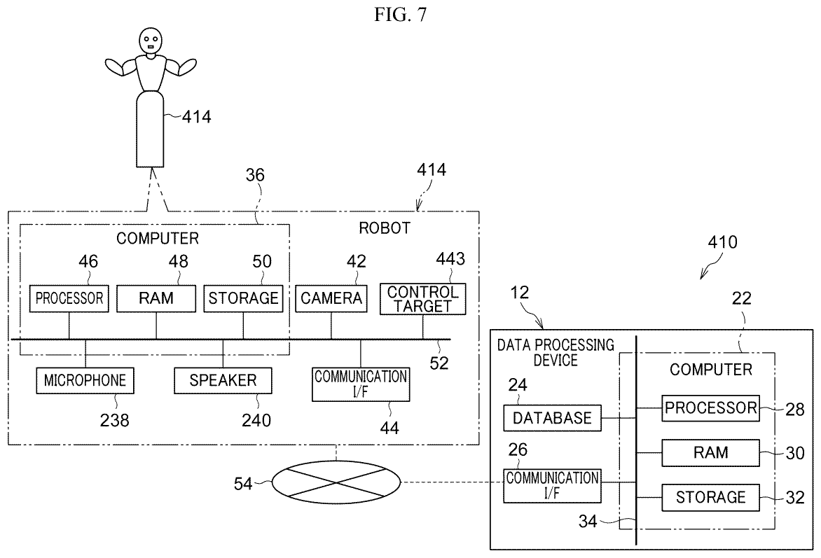

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

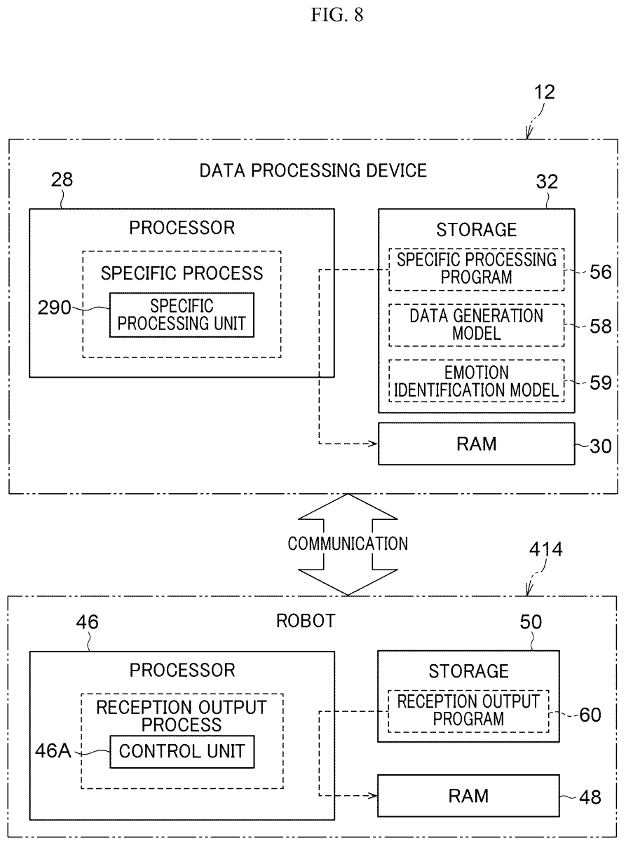

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

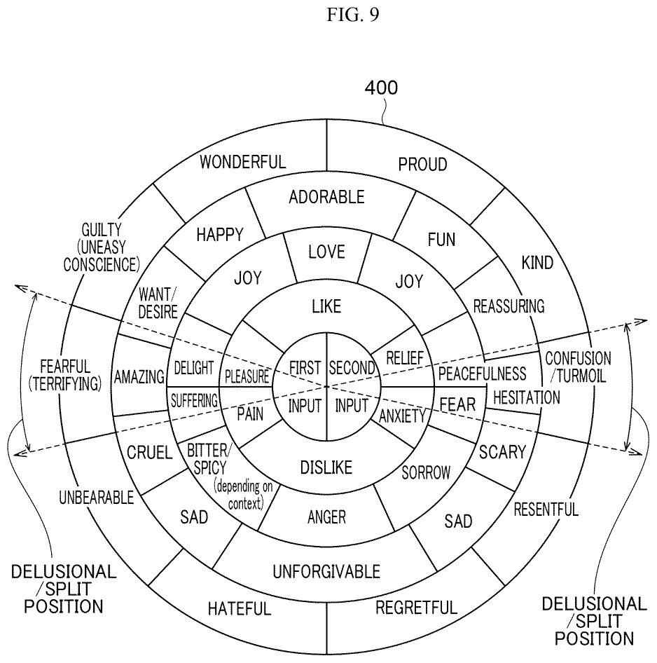

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

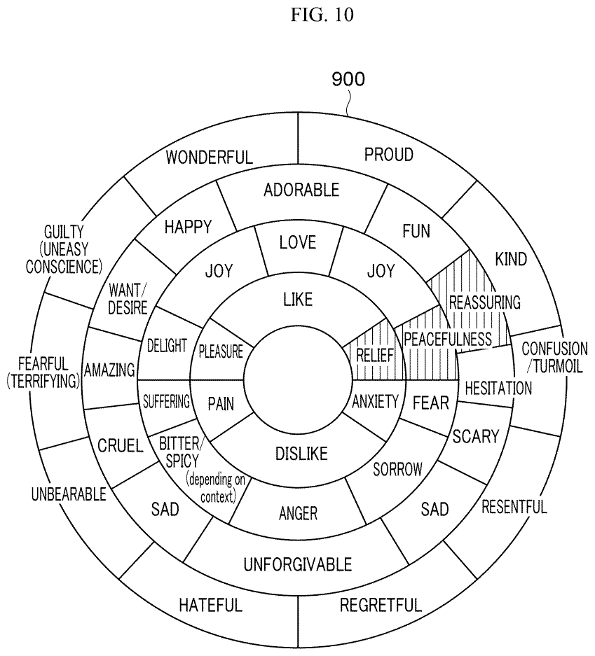

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
receive, via an input/output device of an information processing apparatus, a natural language question from a user,
analyze the received question by using a natural language processing algorithm to perform semantic analysis, feature extraction, and attribute estimation on the question, and construct, based on a result of the analysis, a prompt sentence to be input to a generative information processing model,
supply the constructed prompt sentence to the generative information processing model as input data, cause the generative information processing model to execute statistical language inference processing to generate a response sentence related to an agricultural field, and convert a result of the generation into response data in an output data structure capable of being presented to the user,
store question data received from the user and response data generated by the generative information processing model in association with identification information and time information in a storage area of a recording device,
analyze a plurality of stored question-and-response data items by using data analysis algorithms including classification processing, aggregation processing, and time-series processing and by using vectorization and similarity calculation processing performed by the generative information processing model, thereby performing trend recognition and demand extraction, and derive, based on a result of the analysis, commercialization candidate information related to an agricultural service or an agricultural product, and provide the derived commercialization candidate information to an output device for an administrator.

### Supplementary 2

The system according to supplementary 1,
wherein the processor is configured to
perform acoustic feature extraction processing on voice data of the user and image feature extraction processing on image data of the user received via the input/output device, estimate an emotional state of the user by using a machine learning model based on the extracted features, and change, according to the estimated emotional state, at least one of a condition description in the prompt sentence and an output control parameter of the generative information processing model used for generation of the response data.

### Supplementary 3

The system according to supplementary 1,
wherein the processor is configured to
execute, on the stored question-and-response data, frequency aggregation processing and similar-question clustering processing for each of at least one of a crop type, a cultivation-environment type, and a user-attribute type, extract a high-demand field by calculating distances between clusters using embedding representations obtained by the generative information processing model or by a separate language expression model, and identify, for each extracted high-demand field, at least one of a continuous information-provision service, a material-provision service, and an educational-content-provision service as a commercialization candidate.

### Application Example 1

### Supplementary 1

A system comprising a processor,
wherein the processor is configured to
receive, from a terminal including an input/output device and a communication device, audio data representing a voice question spoken by a user;
transmit the audio data to a speech recognition information processing apparatus and obtain, based on the audio data, character data representing a question sentence from the user;
generate a prompt sentence including the question sentence and an instruction sentence indicating a response policy related to agricultural work, and input the prompt sentence to a generative information processing model in order to cause the generative information processing model to generate a response sentence related to the agricultural work;
store, in a storage device, information including the question sentence and the response sentence, thereby accumulating a correspondence relationship between questions and responses;
transmit the response sentence to a speech synthesis information processing apparatus and obtain synthesized audio data based on the response sentence;
transmit the synthesized audio data to the terminal and cause the terminal to present the response to the user via an acoustic output device of the terminal; and
analyze the accumulated correspondence relationship between questions and responses stored in the storage device and generate an analysis result for evaluating a possibility of business development related to support for agricultural work.

### Supplementary 2

The system according to supplementary 1,
wherein the processor is configured to
recognize an emotional state of the user by analyzing audio data and image data of the user, and adjust content of the prompt sentence or the response sentence in accordance with the emotional state.

### Supplementary 3

The system according to supplementary 1,
wherein the processor is configured to
cooperate with a terminal mounted on an agricultural work machine so that the user can input the voice question while operating the agricultural work machine, and so that the synthesized audio data based on the response sentence is output in real time from the acoustic output device of the agricultural work machine.

### Example 2

### Supplementary 1

A system comprising a processor,
wherein the processor is configured to
provide a user interface on an information input/output device of a terminal to receive, via the user interface, a natural language question related to an agricultural field from a user, and accept the natural language question as input data,
preprocess the input data by performing at least character normalization, removal of unnecessary symbols, and length constraint checking, execute syntactic analysis and semantic analysis on the preprocessed input data by using a natural language processing algorithm,
extract attribute information indicating at least a target crop, a cultivation environment condition, and a problem type from the input data, and generate a prompt sentence including the attribute information and convert the prompt sentence into an input format of a generative AI model,
collect guidance data including expert knowledge in the agricultural field from an external source, generate a training data set representing a correspondence between a question sentence and an answer sentence on the basis of the guidance data, and train the generative AI model by optimizing parameters of the generative AI model using a machine learning framework,
provide, to the generative AI model, extended input data including at least the prompt sentence or the prompt sentence to which a part of a past question-and-answer record and a part of expert knowledge data selected according to a question similarity are added, and execute inference processing of sequentially generating a response candidate related to the agricultural field on the basis of the extended input data and outputting a response sentence as natural language text,
postprocess the response sentence by performing at least unit conversion, expression unification, and structuring of important items, and transmit, to the terminal, response information including information indicating at least a crop name, a recommended temperature range, a recommended humidity range, and a soil acidity range, and cause the response information to be presented to the user,
store the question sentence from the user and the response sentence as a record including at least question text, answer text, crop attribute, and time information in a data storage device, and perform aggregation processing and similarity calculation processing on a plurality of stored records to generate analysis data related to selection of data for retraining of the generative AI model and a possibility of new commercialization, and
in response to acceptance of a new question sentence from the user, perform a neighborhood search processing on the stored records on the basis of a feature vector, acquire a past question-and-answer record having a similarity equal to or greater than a predetermined threshold, and add an acquisition result of the past question-and-answer record to the prompt sentence to improve response generation performance of the generative AI model.

### Supplementary 2

The system according to supplementary 1,
wherein the processor is configured to
perform recognition processing of estimating an emotional state of the user on the basis of a feature amount extracted from an audio signal and an image signal of the user, and execute response adjustment processing of changing at least expression intensity, explanation detail level, and advice content of the response sentence in accordance with the emotional state.

### Supplementary 3

The system according to supplementary 1,
wherein the processor is configured to
perform analysis processing on the plurality of stored records to calculate at least a question frequency per crop type, a distribution per problem type, and a tendency per regional attribute, generate business candidate information related to at least a service provision form, a fee structure, or an additional knowledge provision module on the basis of a result of the analysis processing, and, at a time of retraining of the generative AI model, adjust extraction conditions of the training data set and learning parameters in consideration of the business candidate information.

### Application Example 2

### Supplementary 1

A system comprising a processor,
wherein the processor is configured to
acquire inquiry information from a user via an input apparatus,
perform preprocessing on the acquired inquiry information by using language processing technology to identify an intention and a domain of the inquiry information, and dynamically generate a prompt sentence for input to a generative AI model based on a result of the identification and on user state information,
acquire, from a storage apparatus, domain-specific knowledge information corresponding to a target included in the inquiry information and user history information, and integrate the domain-specific knowledge information and the user history information into the prompt sentence as context information,
supply input information including the prompt sentence to the generative AI model, cause the generative AI model to generate response candidate information by inference processing, and determine final response information by performing token sequence selection processing or output control processing based on a probability distribution on the response candidate information, and
present the final response information to the user via an output apparatus, and store, in the storage apparatus, the inquiry information, the prompt sentence, the final response information, and the user state information in association with one another, and update the language processing technology or the generative AI model by using stored information as learning data.

### Supplementary 2

The system according to supplementary 1,
wherein the processor is configured to
acquire user state information including audio information and image information from the user, perform emotion estimation processing including audio feature analysis processing and facial feature analysis processing on the user state information to identify a user emotion, and generate emotion-adaptive response information by changing, according to the identified user emotion, tone instruction information and explanation-detail instruction information in the prompt sentence and/or modifying expression content of the final response information.

### Supplementary 3

The system according to supplementary 1,
wherein the processor is configured to
record the inquiry information, the final response information, and user emotion information as inquiry history information in a data storage apparatus, perform statistical analysis processing or machine learning processing on the inquiry history information to extract domain-specific demand-trend information or service-improvement candidate information, and update at least one of generation rules for the prompt sentence, learning data for the generative AI model, and business planning information by using the extracted information.

What is claimed is:

1. A system comprising:
circuitry configured to:
receive, via a communication interface coupled to a packet-switched network, a natural language question from a terminal device;
analyze the natural language question by using a natural language processing algorithm to perform semantic analysis, feature extraction, and attribute estimation, and construct, based on an analysis result, a prompt sentence to be input to a generative neural network model;
supply the prompt sentence to the generative neural network model, cause the generative neural network model to execute statistical language inference processing to generate a response sentence related to a domain-specific field, and convert a generation result into response data in an output data structure;
store question data and response data in association with identification information and time information in a storage device;
analyze a plurality of stored question-and-response data items by using data analysis algorithms comprising classification processing, aggregation processing, and time-series processing and by using vectorization and similarity calculation processing, thereby performing trend recognition and demand extraction, and derive service candidate information based on an analysis result; and
transmit a notification data packet comprising the response data to the terminal device via the communication interface.

2. The system according to claim 1, wherein the circuitry is configured to perform acoustic feature extraction processing on voice data received from the terminal device and image feature extraction processing on image data received from the terminal device, estimate an emotional state of a user by using a machine learning model based on extracted features, and change at least one of a condition description in the prompt sentence or an output control parameter of the generative neural network model based on the estimated emotional state.

3. The system according to claim 2, wherein the circuitry is configured to, when the estimated emotional state indicates anxiety, adjust the prompt sentence to include a reassurance instruction and a simplified explanation level, and when the estimated emotional state indicates confidence, adjust the prompt sentence to include a detailed technical explanation level.

4. The system according to claim 1, wherein the circuitry is configured to execute, on the stored question-and-response data, frequency aggregation processing and similar-question clustering processing for each of at least one of a subject type, an environment type, or a user-attribute type.

5. The system according to claim 4, wherein the circuitry is configured to extract a high-demand field by calculating distances between clusters using embedding representations obtained by the generative neural network model, and to identify, for each extracted high-demand field, at least one of a continuous information-provision service, a material-provision service, or an educational-content-provision service as the service candidate information.

6. The system according to claim 1, wherein the generative neural network model comprises a transformer-based architecture including multiple self-attention layers and feed-forward layers, and wherein the circuitry is configured to control at least one of a temperature parameter or a top-k sampling threshold during generation of the response sentence.

7. The system according to claim 1, wherein the circuitry is configured to receive audio data from the terminal device, transmit the audio data to a speech recognition processing apparatus to obtain character data representing the natural language question, and use the character data as input for the natural language processing algorithm.

8. The system according to claim 7, wherein the circuitry is configured to transmit the response sentence to a speech synthesis processing apparatus, obtain synthesized audio data based on the response sentence, and transmit the synthesized audio data to the terminal device for acoustic output.

9. The system according to claim 1, wherein the prompt sentence comprises the natural language question and an instruction sentence indicating a response policy related to the domain-specific field, and wherein the circuitry is configured to dynamically modify the instruction sentence based on at least one of a user attribute or a question category.

10. The system according to claim 1, wherein the circuitry is configured to perform real-time sensor data acquisition from at least one of a temperature sensor, a humidity sensor, or an image sensor connected to the terminal device, and to include sensor data in the prompt sentence as contextual information for the generative neural network model.

11. The system according to claim 10, wherein the circuitry is configured to apply image recognition processing to image data from the image sensor to detect at least one of an object category, a condition indicator, or an anomaly indicator, and to include detection results in the prompt sentence.

12. The system according to claim 1, wherein the circuitry is configured to classify the natural language question into a question category by applying a classification model to feature vectors extracted from the natural language question, and to select a domain-specific knowledge base segment from the storage device based on the classified question category for inclusion in the prompt sentence.

13. The system according to claim 1, wherein the circuitry is configured to generate a follow-up question based on the response data and the analysis result, transmit the follow-up question to the terminal device, receive an additional response, and iteratively refine the prompt sentence based on accumulated dialogue context.

14. The system according to claim 1, wherein the circuitry is configured to provide the service candidate information to an administrator terminal device via the communication interface, the service candidate information comprising trend indicators, demand frequency data, and identified service opportunities.

15. The system according to claim 1, wherein the circuitry is configured to store user profile information comprising at least a skill level indicator and a preference indicator, and to adjust the prompt sentence based on the user profile information to generate a response sentence appropriate for the skill level of the user.

16. The system according to claim 1, wherein the circuitry is configured to receive the natural language question from a wearable information display apparatus serving as the terminal device, and to transmit the response data for display as visual information superimposed on a display unit of the wearable information display apparatus.

17. The system according to claim 1, wherein the circuitry is configured to apply information-protection processing comprising at least access control and encryption to the stored question-and-response data items.

18. A system comprising:
circuitry configured to:
receive, via a communication interface coupled to a packet-switched network, a natural language question comprising at least one of character data or audio data from a terminal device, and when the question comprises audio data, apply speech recognition processing to generate character data;
analyze the character data using a natural language processing algorithm to perform semantic analysis and feature extraction, classify the question into a question category, and construct a prompt sentence comprising the character data, an instruction sentence related to a domain-specific field, and contextual information;
input the prompt sentence to a generative neural network model comprising a transformer-based architecture, cause the generative neural network model to generate a response sentence, estimate an emotional state of a user based on at least one of acoustic features or image features received from the terminal device, and adjust at least one of the prompt sentence or an output control parameter based on the estimated emotional state;
store question data and response data in a storage device, execute frequency aggregation processing and similar-question clustering processing on accumulated question-and-response data, calculate distances between clusters using embedding representations, and derive service candidate information based on extracted high-demand fields; and
transmit, via the communication interface, a notification data packet comprising the response data to the terminal device, and provide the service candidate information to an administrator terminal device.

19. The system according to claim 18, wherein the circuitry is configured to receive sensor data comprising at least one of temperature data, humidity data, or image data from the terminal device, apply image recognition processing to detect condition indicators, and include the sensor data and detection results in the prompt sentence as contextual information.

20. A method comprising:
receiving, via a communication interface coupled to a packet-switched network, a natural language question from a terminal device;
analyzing the natural language question by using a natural language processing algorithm to perform semantic analysis, feature extraction, and attribute estimation, and constructing a prompt sentence based on an analysis result;
supplying the prompt sentence to a generative neural network model, causing the generative neural network model to generate a response sentence related to a domain-specific field, and converting a generation result into response data;
storing question data and response data in association with identification information and time information in a storage device;
analyzing a plurality of stored question-and-response data items by using data analysis algorithms comprising classification processing, aggregation processing, and time-series processing and by using vectorization and similarity calculation processing, performing trend recognition and demand extraction, and deriving service candidate information; and
transmitting a notification data packet comprising the response data to the terminal device via the communication interface.
